(19) United States
(12) Patent Application Publication
(10) Pub. No.: US 2007/0011081 A1
(43) Pub. Date: Jan. 11, 2007

(54) Systems and methods for delivering parameters to automated security order execution systems

(75) Inventors: Tomas Bok, Somerville, MA (US); David Charles Cushing, Lexington, MA (US); David Andrew Jack, South Orange, NJ (US); Sanjoy Roy Choudhury, Stamford, CT (US)

Correspondence Address: MORGAN LEWIS & BOCKIUS LLP, 1111 PENNSYLVANIA AVENUE NW, WASHINGTON, DC, 20004, US

(73) Assignee: Lehman Brothers Inc., New York, NY (US)

(21) Appl. No.: 11/485,030

(22) Filed: Jul. 11, 2006

Related U.S. Application Data
(60) Provisional application No. 60/698,219, filed on Jul. 11, 2005.

(51) Int. Cl. G06Q 40/00

(52) U.S. Cl. 705/37

(57) ABSTRACT

In one aspect, the present invention permits users of trading algorithms to jointly achieve the objectives described above, namely: (a) permit access to trading algorithms of (arbitrary) complexity without requiring proprietary protocol extensions; (b) allow users to easily identify and store one or more sets of dynamic vs. static parameters (and related details, including user interface layout); and (c) allow any given pre-defined set of parameters to be easily invoked and used to submit orders. In another aspect, the invention comprises a computer system comprising: (a) an authoring tool operable to enable a user to design custom trading strategies and create interface definitions; and (b) a pre-processor operable to receive a custom strategy order message delivered via a standard protocol, load an definition for a corresponding custom strategy, enrich the order message based on the definition, and pass the enriched message to a trading strategy destination.

### CROSS REFERENCE TO RELATED APPLICATIONS

This application claims the benefit of U.S. Provisional Application No. 60/698,219, filed Jul. 11, 2005. The entire contents of that provisional application are incorporated herein by reference.

### BACKGROUND

The securities industry is continuing to experience an increasing degree of automation. One area of especially rapid growth is in automated execution of security orders by software programs. These programs are known popularly as “trading algorithms.”

Such programs take as inputs order information (e.g., security identifier and quantity) and user-specified preferences (e.g., maximum or minimum allowable execution price and target amount of time over which to operate). Collectively, these inputs are called parameters, and their primary functions are to: (a) specify desired execution objectives; and (b) govern the behavior of the program, within designer-specified boundaries, in pursuit of the objectives. These programs also process both real-time and historical data as a typical part of their operation.

In order for users to successfully access trading algorithms, they usually must package the inputs into a message (effectively a data structure) of moderate to high complexity. This message typically is comprised primarily of a collection of parameters.

Today, much security order information (and most trading algorithm order information) is transmitted from sender to receiver via an industry protocol known as Financial Information Exchange (“FIX”). FIX was originally designed to transmit order parameters for orders in a single security, with a limited, pre-defined set of parameters. When the usage of FIX expanded to include the transmission of orders to trading algorithms (as well as other applications, such as transmitting multiple orders to be executed in coordination with one another), the protocol was expanded somewhat to accommodate basic trading algorithm types.

Today, so-called “next generation” trading algorithms are starting to emerge that require much more extensive and complex parameter sets. Generally speaking, vendors of such trading algorithms cannot offer them to prospective users (or third party vendors who supply order entry software to prospective users) without defining proprietary extensions to the FIX protocol or other specialized solutions. Prospective users, who are typically employing trading algorithms offered by multiple vendors, are understandably reluctant to support multiple proprietary protocol extensions. Even vendors prefer not to extend the protocol because such extensions give rise to a costly cycle of promulgation and certification. Such extensions also increase the probability of service failure due to improperly formed messages.

At the same time, users of next-generation trading algorithms want to take advantage of the expanded capabilities of those algorithms, but usually prefer to specify (upon initial setup of the interface) only a subset of their choosing (i.e., customized) of the total parameter set to be supplied at the time of order submission (dynamic parameters), while setting other parameters to pre-defined (static) values of their choosing and allowing still other parameters to remain unspecified or to take on vendor-established default values. Submission-time (dynamic) values may be optional or mandatory, and may or may not have default values. A user also may wish to specify upon initial setup a range of allowable values for submission-time parameters.

Users also want to be able to easily invoke previously-saved, customized parameter sets and employ them to direct security orders to the underlying trading algorithms.

### SUMMARY

In one aspect, the present invention permits users of trading algorithms to jointly achieve the objectives described above, namely: (a) permit access to trading algorithms of (arbitrary) complexity without requiring proprietary protocol extensions; (b) allow users to easily identify and store one or more sets of dynamic vs. static parameters (and related details, including user interface layout); and (c) allow any given pre-defined set of parameters to be easily invoked and used to submit orders.

In another aspect, the invention comprises a computer system comprising: (a) an authoring tool operable to enable a user to design custom trading strategies and create interface definitions; and (b) a pre-processor operable to receive a custom strategy order message delivered via a standard protocol, load an definition for a corresponding custom strategy, enrich the order message based on the definition, and pass the enriched message to a trading strategy destination.

In various embodiments: (1) the definition is encoded using a protocol for encoding the custom trading strategies and interface definitions for transmission and storage; (2) the standard protocol is a FIX protocol; (3) the authoring tool is operable to enable a user to designate one or more input parameters as either a static parameter or a dynamic parameter; and (4) the dynamic parameter may further be designated as a required input or an optional input.

In another aspect, the invention comprises a computer-implemented method comprising: (a) receiving a definition for an advanced approach strategy; (b) storing the definition for the advanced approach strategy in a database; and (c) based on the definition, integrating and deploying the advanced approach strategy.

In various embodiments: (1) the definition for an advanced approach strategy comprises: (a) a strategy name; (b) data identifying a parent algorithm; (c) a manifest; (d) a custom parameters definition; and (e) a custom interface definition; (2) the manifest enumerates a list of parameters of the parent algorithm and identifies which of the parameters are static and which are dynamic; (3) the parent algorithm is operable to receive FIX messages; (4) the manifest comprises one or more static parameter values and one or more dynamic parameter values; (5) the static parameter values are transcribed in a manner essentially identical to a manner in which the static parameter values would be defined in a FIX message; and (6) a placeholder is used to identify a location where a passed-in value for a dynamic parameter should be inserted.

In another aspect, the invention comprises software stored on a computer readable medium and operable to enable a user to author a custom trading strategy via a graphical user interface, wherein the graphical user interface is configured to allow the user to: (a) assign static parameter values to be fixed; (b) identify dynamic parameters to be exposed; and (c) set default values for the dynamic parameters.

In various embodiments: (1) the software is further operable to store a custom strategy comprising: a parent algorithm name; and a manifest; (2) the manifest comprises data identifying pre-defined static parameter values and dynamic parameters; (3) the manifest further comprises data identifying default parameter values for the dynamic parameters; (4) the graphical user interface is further configured to allow the user to identify one or more base actions, one or more conditional actions, and one or more conditions; (5) the manifest is stored as an XML string or a FIX string; and (6) the software is further operable to store a custom strategy comprising at least one of: a custom parameters definition and a custom interface definition.

In another aspect, the invention comprises a computer system comprising: (a) an authoring tool operable to enable a user to design custom trading strategies and interfaces; (b) an order entry object interpreter operable to receive parameter values and form the values into a message transmitted via a standard protocol; and (c) a data structure packager operable to receive the message from the order entry object interpreter, form the message into a data structure, and transmit the data structure to a trading strategy destination.

In another aspect, the invention comprises a computer-implemented method comprising: (a) displaying a graphical user interface operable to allow a user to enter a definition for an advanced approach strategy; (b) receiving data entered by the user defining an advanced approach strategy; and (c) transmitting the definition for the advanced approach strategy to a parent algorithm.

The above-described aspects and embodiments are not intended to be limiting. Those skilled in the art will perceive other aspects and embodiments after reviewing the drawings and the detailed description.

### BRIEF DESCRIPTION OF THE DRAWINGS

FIG. 1 depicts a graphical representation of a preferred system and method for delivering parameters to automated security order execution systems.

FIG. 2 depicts a preferred TactEx Interface display.

FIG. 3 depicts a preferred Custom Strategy Definition display.

FIG. 4 depicts a preferred Simple Custom Strategy Interface display.

FIG. 5 depicts a preferred Sitter Algorithm Interface display.

FIG. 6 depicts examples of possible Time parameter controls.

FIG. 7 depicts preferred control type definitions.

FIG. 8 depicts a Custom Strategy interface example.

FIG. 9 depicts another Custom Strategy interface Example

FIG. 10 depicts a preferred method of building a Custom Strategy.

FIG. 11 depicts a preferred LMX CAT algorithm interface.

FIG. 12 depicts a preferred CAT authoring tool with checkboxes.

FIG. 13 depicts a CAT authoring tool example.

FIG. 14 depicts a preferred Time Configuration Tab display.

FIG. 15 depicts a preferred Base Action Tab: VWAP display.

FIG. 16 depicts a preferred Base Action Tab: TWAP display.

FIG. 17 depicts a preferred Base Action Tab: With Volume display.

FIG. 18 depicts a preferred Base Action Tab: Target Strike display.

FIG. 19 depicts a preferred Conditional Action Tab: VWAP display.

FIG. 20 depicts a preferred Conditional Action Tab: TWAP display.

FIG. 21 depicts a preferred Conditional Action Tab: With Volume display.

FIG. 22 depicts a preferred Conditional Action Tab: Target Strike display.

FIG. 23 depicts a preferred Conditional Action Tab: Fast Exec display.

FIG. 24 depicts a preferred Condition Tab: Price Condition display, with an absolute trigger price type.

FIG. 25 depicts a preferred Condition Tab: Price Condition display, with a relative trigger price type.

FIG. 26 depicts a preferred Condition Tab: Time Condition display.

FIG. 27 depicts a preferred Condition Tab: Size on Opposite Side Condition display.

FIG. 28 depicts a preferred Condition Tab: Bid/Ask Spread Condition display.

FIG. 29 depicts a preferred Condition Tab: Relative Return Condition display.

FIG. 30 depicts a preferred Condition Tab: Filled Size Condition display.

FIG. 31 depicts a preferred Custom Interface Preview display.

### DETAILED DESCRIPTION

A preferred embodiment of this invention comprises three closely integrated software applications, each of which is described below.

The first software application (“authoring tool”) allows a strategy designer (who may or may not be an end user) to:
a) select a base trading algorithm from a list of those offered by a vendor;
b) be guided through a process of selecting which parameters will be dynamic and which will be static;
c) assign values to static parameters;
d) assign default values and allowable ranges to dynamic parameters;
e) design an appropriate dynamic order parameter entry template; and ‘f) associate the above elements (collectively, an “order entry object”) with a name and save the object to an appropriate database.

The object that is stored in the database will, in turn, be readable and interpretable at the time of order entry by a second software application (“custom order entry object interpreter”) whose job is to:
a) present the interface associated with the object;
b) store the dynamic parameter values that are subsequently entered by the user into the interface; and
c) form these values into a message of arbitrary length that can be transmitted to a third software application at the service provider's site via the FIX protocol (as modified by a universally applicable extension to that protocol, described below in the section entitled “Algorithmic Trading Extensions”).

The function of the third software application (“FIX packager”) (or, more generally, a “data structure packager”) is to receive the enhanced FIX message (possibly combining it with other information read from an associated database), form it into a valid data structure, and transmit this structure to the ultimate trading strategy destination.

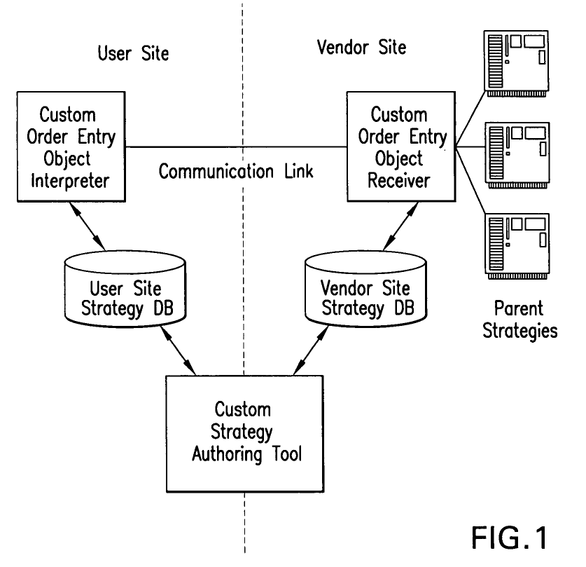

FIG. 1 shows how elements of one embodiment of the invention work together.

Aspects of components of this invention have been previously used on a stand-alone basis in this area. For example, the idea of enriching a security order that is destined for a trading algorithm by looking up static information (stored in a database) and attaching it to that order has been used before. Similarly, static, non-customizable interfaces have been used to set parameter values that are ultimately passed along to the target trading algorithm. However, such schemes are static and furthermore do not solve the joint problems of: (a) being able to create and deploy complex new trading algorithms dynamically; (b) having the interfaces to such algorithms be easily tailored to individual needs (including risk management) and preferences of end users; and (c) not requiring frequent, proprietary extensions of the industry standard protocol, namely FIX.

Collectively, the benefits created by this invention dramatically extend the capabilities of trading algorithms, and substantially reduce the time it takes to bring new trading algorithm concepts to market.

A trading algorithm is an engine that executes orders automatically according to a pre-defined set of instructions. Examples of trading algorithms are those used by Lehman Brothers, which include VWAP, Target Strike, CAT, and TactEx, among others. Each of these algorithms has a specific purpose and trading style, but each also allows a user to specify certain input parameters to further define how the algorithm should trade a specific order. Examples of such input parameters include start and end times, volume constraints, urgency levels, etc. These parameters allow a single trading algorithm to be used flexibly to cover a variety of different applications.

In some cases, trading algorithms present users with such a wide variety of parameter choices that it is desirable to allow users or developers to create and store streamlined variants based on the full algorithm. This process essentially consists of two steps: (1) “nailing down” (i.e., pre-determining and storing) a subset of the available parameters; and then (2) presenting an end user with a simplified interface that allows the user to enter the remaining parameters that were not fixed in step (1). A custom strategy is associated with a “parent” trading algorithm (which serves as its foundation) and consists of a subset of predefined parameter settings for the parent algorithm, and a set of placeholders to identify any further parameters that will later need to be specified.

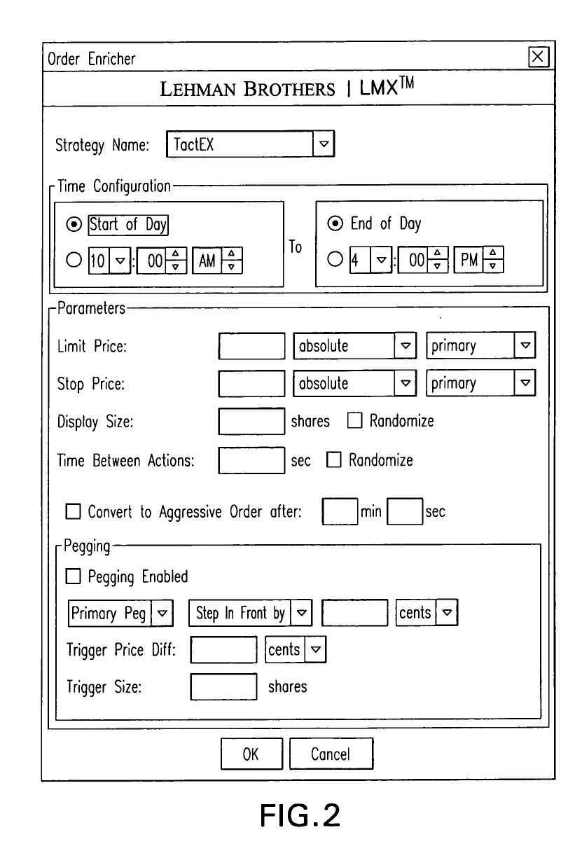

A simple example will illustrate this. FIG. 2 shows the full interface for the TactEx trading algorithm. There are about 10 different groups of parameters that can be selected to configure the TactEx trading algorithm to implement various trading styles.

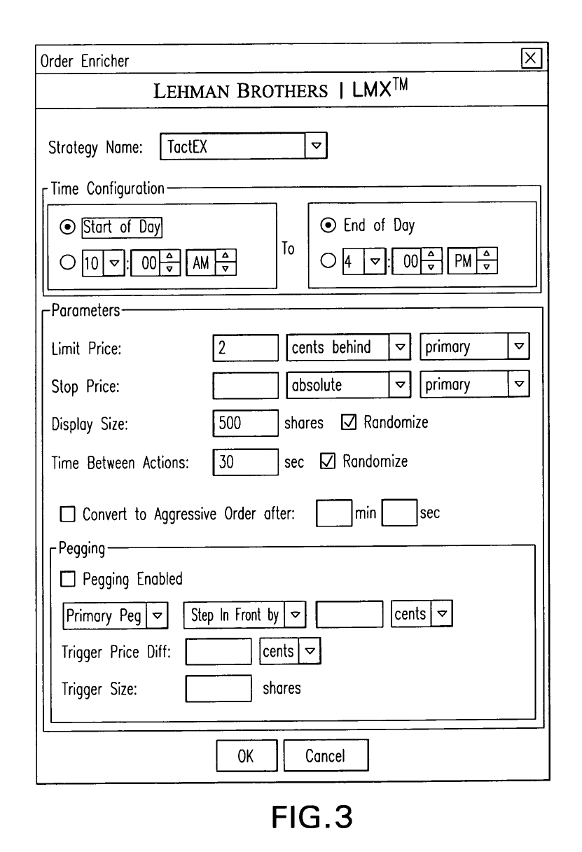

FIG. 3 shows an example of a custom TactEx strategy definition. In this case, the custom strategy has predefined a number of parameters. Limit price=“2 cents behind primary”, display size=500 shares, time between actions=30 sec, and randomization options have been switched on for both display size and time between actions. Note that the parameters that are left alone may have been implicitly specified by leaving them off. In other words, the custom strategy has been defined to leave the Pegging and Convert to Aggressive features switched off.

The point is to define these parameter settings once (the custom strategy) and then allow end users to access the strategy without retyping parameter settings or even seeing the full TactEx interface. Instead, users can be presented with a simplified interface that exposes only a subset of the TactEx parameters to the end user. Or, if there are no missing parameter values required by the TactEx algorithm, the end user can bypass the interface altogether and submit orders to the custom strategy directly.

It is important to distinguish between two types of custom strategies, with the critical distinction being whether the strategy allows an end user to specify additional parameters when submitting orders. The advanced approach is used when the end user is to be presented with a customized interface allowing the user to specify additional parameters. The basic approach is used when all required parameters are pre-specified and the user can send orders to the custom strategy directly without using an interface.

Static parameters are parameters that are pre-defined and cannot be modified when sending an order. Dynamic parameters are parameters that can be specified by the end-user when submitting an order to the custom strategy.

In the basic approach, all required parameters are static and there are no dynamic parameters. A designer simply names the new custom strategy (say “Passive”), stores the strategy in a database, and systems are configured so that any incoming orders with strategy name set to “Passive” are handled by automatically loading the stored (predefined) parameter settings and passing those settings on to the parent algorithm. The end user is not provided with any interface. The user simply sends in orders tagged with the name of the custom strategy. Typically, the custom strategy is presented as a destination within a menu of routing options on the user's trading workstation.

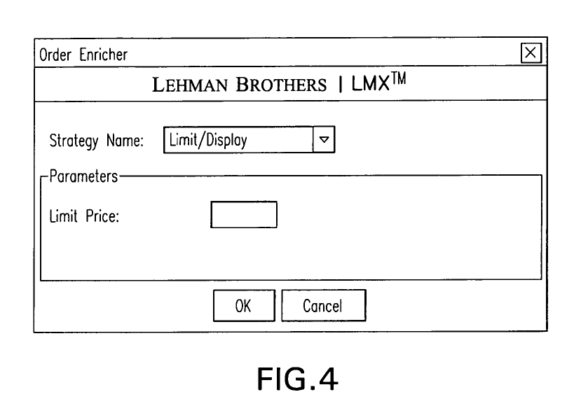

In the advanced approach, some but not all required parameters are static and the end user is able to set a short list of dynamic parameters using a custom interface or through some electronic protocol. Returning to the example in FIG. 3, a designer might want to allow an end user to modify the Limit Price parameter each time an order is sent to the custom strategy. The designer would create a simple interface (see FIG. 4) to accomplish this.

Note that advanced approach custom strategies can be implemented either by providing a custom graphical interface that integrates with the end user's trading workstation, or by simply providing a specification to the end user and allowing the user to create his own interface or even set the required parameters programmatically.

Defining an advanced approach strategy involves not only pre-defining static parameters (as with the basic approach) but also defining a graphical interface and/or electronic protocol through which the user can set the dynamic parameters. Each dynamic parameter must be defined and mapped to order fields so that the parameter may be passed electronically. If the end user is to be presented with a custom interface, the layout, field labels, field types, and default values also must be defined.

Regardless of approach, there is some behind-the-scenes work to process an incoming custom strategy order, load the appropriate parameter settings, and forward the order on to the parent trading algorithm. The pre-processor is the module that performs this task, converting simplified custom strategy orders into complex, fully-specified parent algorithm orders. This conversion process can occur upstream of the parent algorithm (which need not have any awareness of custom strategy definitions, or of any distinction between regular and custom strategy orders). For advanced approach strategies, the pre-processor must be capable of parsing incoming dynamic parameter values and incorporating these values into the parent algorithm order.

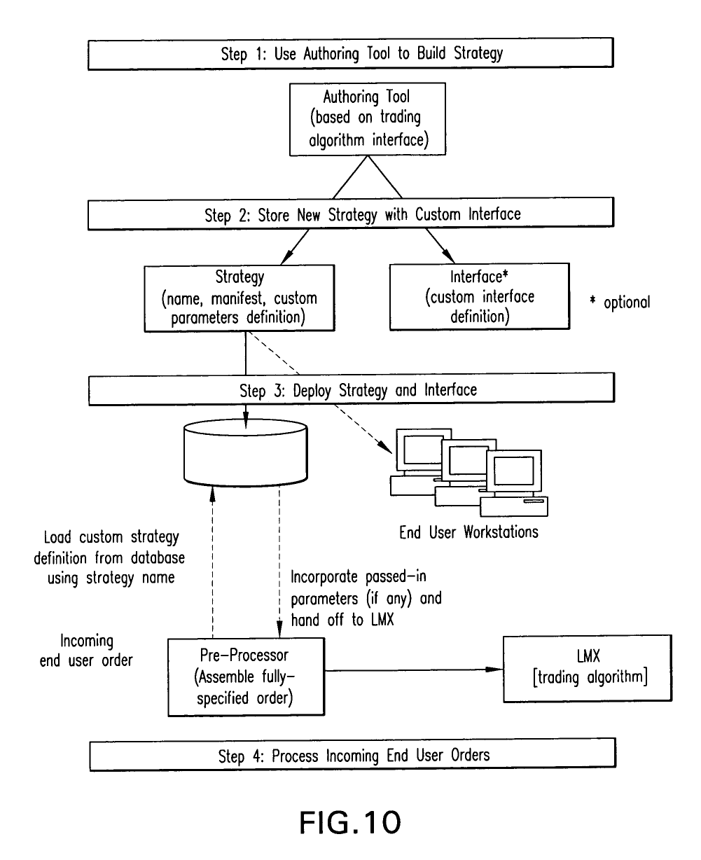

The remainder of this section explains the steps and components required to implement a new custom strategy, following the format depicted in FIG. 10.

Step 1: Use Authoring Tool to Build Strategy

An Authoring Tool is an interactive, graphical environment used to design custom strategies and the interfaces used to control them. A user preferably is presented with a graphical interface displaying a full superset of input parameters for a “parent” trading algorithm. More details regarding functionality and structure of a preferred Authoring Tool are provided below in the Authoring Tool Overview section.

For each parameter, the Authoring Tool presents the strategy designer with three options:
(1) designate it as a static parameter and fix (pre-define) the desired parameter value;
(2) designate it as a dynamic parameter and expose it to the end user as a required input via custom interface or some electronic protocol; or
(3) designate it as a dynamic parameter and expose it to the end user as an optional input via custom interface or some electronic protocol.

For basic approach strategies, only option (1) is available: all parent algorithm parameters must be static.

When an advanced approach strategy is created, the Authoring Tool is not only used to pre-define static parameters, but also to define the protocol through which dynamic parameters are to be passed into the pre-processor, and (optionally) to build a custom interface that exposes any required or optional dynamic parameters to the user. For each dynamic variable, the advanced approach designer defines field type (integer, string, date, time, percent, real, or enumerated) and a unique parameter tag that allows the interface to pass the variable into the pre-processor. If the designer is building a custom interface, the designer also needs to define parameter labels, default values, validation instructions, and screen layout.

Step 2: Store New Strategy with Custom Interface

A custom strategy definition preferably comprises the following components:
Custom strategy name (unique string identifier).
Trading algorithm that will serve as the “parent” for the custom strategy.
The manifest: the enumerated set of all pre-defined static parameter values and all parameters that have been designated as dynamic. This is typically stored as an XML string or FIX string.
Custom parameters definition (optional, defined below).
Custom interface definition (optional, defined below).

For basic approach custom strategies, only strategy name, parent algorithm name, and manifest need to be defined. For advanced approach strategies, the custom parameters definition must be defined. The custom interface definition only needs to be defined if the strategy requires a custom interface. Generally, the authoring tool can produce all of these components.

Manifest

The manifest can be defined in any protocol, typically in an XML or FIX (Financial Information eXchange) format. Preferably the manifest is represented in a FIX message format with embedded XML. FIX, a trademark of FIX Protocol Limited, is the industry standard communications format for electronic equity trading (see www.fixprotocol.org). Here is a simple illustrative example:

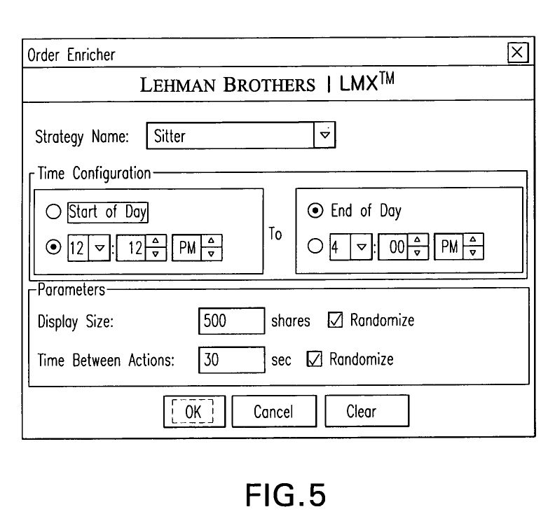

FIG. 5 shows the interface for a hypothetical algorithm called “Sitter”. The strategy takes six parameters. The FIX message generated by the Sitter algorithm interface to pass the parameter settings would look like this (assuming that the end-user typed in the parameter values shown in FIG. 5):

| | |
|---|---|
| 847 | TargetStrategy=1012 |
| 168 | EffectiveTime=12:12:00 |
| 126 | ExpireTime=16:00:00 |
| 957 | TargetStrategyParameters= <Parameters |
| | DisplaySize=”500” |
| | RandomizeDisplaySize=“true” |
| | AverageTimeBetweenActions=“30” |
| | RandomizeTimeBetweenActions=“true” /> |

This message has four lines, each prefixed with a numeric FIX tag that identifies the type of data contained on the line. The first line identifies the algorithm (1012 is the unique numeric ID for the Sitter algorithm). The second and third lines show the start and end times for the order. 168 and 126 are standard FIX tags for controlling the time horizon.

The fourth line (which is broken into five rows in the statement above) is an XML string that contains a collection of additional parameters. The four parameters in the bottom section of the interface in FIG. 5 are all encoded into this XML string.

If one were to develop a custom strategy using Sitter as the parent algorithm, the manifest would look similar to the FIX message above. In fact, if the custom strategy were a basic approach strategy with no dynamic parameters, then the manifest would be identical to this message, except that the first line (TargetStrategy) would be omitted, since both the base algorithm name and the new custom strategy name already are included in the custom strategy definition.

Advanced approach custom strategies need to additionally describe how dynamic parameters are to be handled. This is accomplished through placeholders in the message. All dynamic parameters are represented in the manifest by placeholder strings that occupy the place of where the parameter value would appear in the message. Each placeholder string is the parameter's unique ID code surrounded by pipe (|) characters, like so: |DisplaySz|.

For example, if the display size and end time parameters were designated as dynamic parameters and all others were designated as static, the manifest would look like this:

| | |
|---|---|
| 168 | EffectiveTime=09:30:00 |
| 126 | ExpireTime=\|EndTime\| |
| 957 | TargetStrategyParameters= <Parameters |
| | DisplaySize=”\|DisplaySz\|” |
| | RandomizeDisplaySize=“true” |
| | AverageTimeBetweenActions=“30” |
| | RandomizeTimeBetweenActions=“true” /> |

In this example, EndTime and DisplaySz have been chosen as unique identifiers for those two parameters, as will be explained in the next section.

Custom Parameters Definition

The custom parameters definition is used to define each of the dynamic parameters to be exposed to the end-user. For the custom parameters definition, a FIX message format with a “repeating group” data structure is used as follows:

| | |
|---|---|
| 847 | TargetStrategy = <unique id for the custom strategy> |
| 957 | NoStrategyParameters = <number of dynamic parameters> |
| 958 | StrategyParameterName = “<unique ID of first parameter>” |
| 959 | StrategyParameterType = “<type of first parameter>” |
| 960 | StrategyParameterValue = <value of first parameter> |
| 958 | StrategyParameterName = “<unique ID of second parameter>” |
| 959 | StrategyParameterType = “<type of second parameter>” |
| 960 | StrategyParameterValue = <value of second parameter> |
| | . . . |
| 958 | StrategyParameterName = “<unique ID of last parameter>” |
| 959 | StrategyParameterType = “<type of last parameter>” |
| 960 | StrategyParameterValue = <value of last parameter> |

Each dynamic parameter must be included in the definition with all three definition rows, tagged with 958, 959, and 960.

At a minimum, available parameter types should include:

| | |
|---|---|
| Integer | integer |
| String | text string |
| Time | time format (hh:mm:ss, 24 hour format) |
| Percent | real from 0 to 1 |
| Real | real number (double precision) |
| Boolean | true or false |
| Price | real number (4 decimal places) > 0 |

Beyond this minimal set, the FIX protocol identifies a number of other parameter types such as quantity and currency that would be useful to support as well. For the purposes of this implementation, these are omitted.

The exact order in which the parameters are listed is unimportant for incoming orders. The pre-processor will sort out any discrepancies as long as the correct parameter IDs are supplied.

Note that the custom parameter format has two purposes. The primary purpose is for passing parameters electronically to a trading system. This is done by including the custom parameters definition in the above FIX format to the FIX message representing the order. The second purpose is to serve as a reference point to the pre-processor so that incoming orders can be placed in the correct context. In this second case, the StrategyParameterValue field is ignored.

Custom Interface Definition

The custom interface definition is used as a set of instructions for creating a custom interface to the custom strategy. This interface exposes the various dynamic parameters to the end-user, validates entries, and attaches the parameter values to the order. Preferably, there is an engine that reads the custom interface definition and automatically produces an interface that is consistent with the instructions. Alternatively, a computerized script may read the custom interface definition and automatically produce an interface spec that can be handed to an interface developer to build the interface accordingly. This spec may describe screen layout, field definitions and labels, validation, and the mapping from interface fields to the dynamic parameter fields associated with the order. Finally, of course, the custom interface definition may just be handed to a developer as is, forming a crude set of requirements that can be used to build the interface.

The custom interface definition protocol is quite similar to that of the custom parameters definition, but it adds three additional fields in the format: StrategyParameterLabel (the graphical user interface [GUI] label for the parameter); StrategyParameterControl (the control element type for the GUI); and StrategyParameterValidation (validation instructions for the parameter). Numeric FIX tags are omitted from the definition since this definition is not designed to be passed electronically through FIX lines.

```
TargetStrategy = <unique id for the custom strategy>
NoStrategyParameters = <number of parameters to expose>
      StrategyParameterName = “<unique ID of first parameter>”
      StrategyParameterType = “<type of first parameter>”
      StrategyParameterValue = <default value of first parameter>
      StrategyParameterLabel = “<GUI label for first parameter>”
      StrategyParameterControl = “<GUI control for first param>”
            StrategyParameterValidation = “<Validation for first
      param>”
      ...
      StrategyParameterName = “<unique ID of last parameter>”
      StrategyParameterType = “<type of last parameter>”
      StrategyParameterValue = <default value of last parameter>
      StrategyParameterLabel = “<GUI label for last parameter>”
      StrategyParameterControl = “<GUI control for last param>”
            StrategyParameterValidation = “<Validation for last
      param>”
```

For any custom strategy, there preferably is an exact correspondence between the parameters defined in the custom parameters definition and those in the custom interface definition. The number of parameters in each definition is identical, and the StrategyParameterName and StrategyParameterType settings exactly matches. However, the order of parameters need not be identical.

The legal parameter types are the same as listed above in the Custom Parameters Definition section. StrategyParameterLabel defines the label that will be displayed next to the field on the GUI, and it can take on any string value up to 40 characters. StrategyParameterValue defines default values to be displayed on the interface. If the end user does not change the default value, the interface needs to automatically pass the default value along with the other order parameters. Leaving StrategyParameterValue blank will instruct the interface not to display any default value.

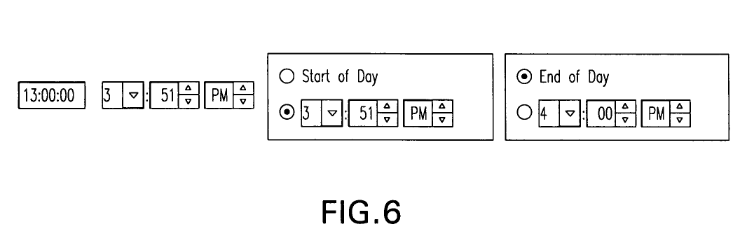

StrategyParameterControl gives the designer options for what type of interface control is used to represent the parameter on the interface. For example, for a parameter with Time type, one could have multiple possible controls on the interface, as shown in FIG. 6.

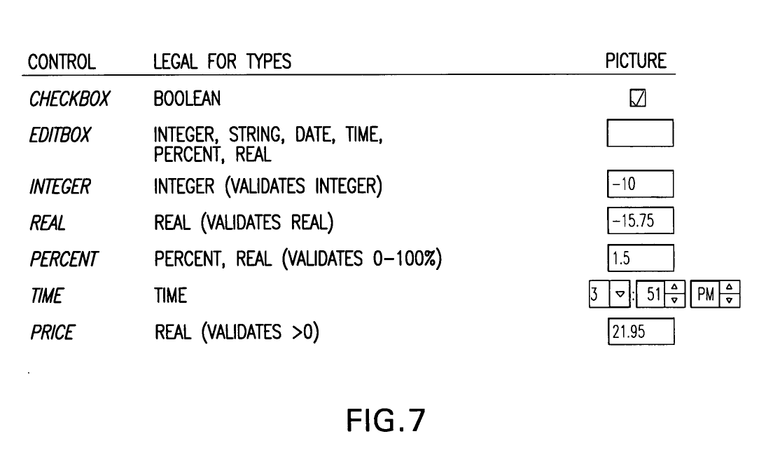

For simplicity, the control types may be defined as shown in FIG. 7.

Extensions of this format may include additional control types (for example, sliders, more time controls, etc.) and additional control over interface layout (parameter groups, side-by-side parameters, spacing, etc.).

It is important to note that when a custom interface definition is created and stored, only an interface definition has been built, not a fully-functional user interface. To deploy the interface, one either hands the definition as a spec to an interface developer, or creates a general tool that automatically generates fully-functioning interfaces based on the interface definitions.

The StrategyParameterValidation field provides validation instructions for each dynamic parameter. These instructions are to be included in the interface design. A string format is used. The method for specifying validation depends on the parameter type (i.e., StrategyParameterType):

All Parameter Types
If no validation is to be performed, just set StrategyParameterValidation=“” (an empty string).
If the \# sequence appears anywhere in the validation string, the parameter is identified as a field that cannot be left blank; a legal value must be specified.

String Type Parameters
Enumerate legal values using the | (pipe) character as a delimiter.
If the \ˆ character sequence appears anywhere in the validation string, case (upper/lower) will be ignored.
Ex: StrategyParameterValidation=“\ˆred|blue|green|black”.

Integer/Real/Percent/Price Type Parameters
Use the StrategyParameterValidation string to identify the valid interval using standard interval notation, e.g. (0,1].
A comma separates the min and max value.
The ( ) characters are used to indicate open interval start and end respectively.
The [ ] characters are used to indicate closed interval start and end respectively.
The min and max numbers indicated should be in legal units given the parameter type. Examples:
   integer type: “[2,10]”,
   percent type: “(0.0,0.99]”
   and so on
To indicate a case where there is no upper or lower bound, you would omit the relevant number. Ex: “[0,)” indicates a parameter with lower bound of 0 and no upper bound.

Examples:

StrategyParameterValidation = “[1,5]” → legal values = { 1,
2, 3, 4, 5}
StrategyParameterValidation = “(1,5]” → legal values = { 2,
3, 4, 5}
StrategyParameterValidation = “[0.0,1.0)” → legal values
= { 0 <= X < 1 }
StrategyParameterValidation = “[1,)” → legal values =
{ any positive integer }

Time Type Parameters
The validation string format for Time type parameters is the same as for Integer/Real/Percent/Price type: an interval is defined using min and max values and the ( ) and [ ] characters to identify open and closed intervals.
The min and max numbers should be in the standard time format: e.g., “[09:30:00,16:00:00]”.
In addition to entering specific start and end times for the min and max numbers in the validation string, the following codes can be used:
   MO: official market open time.
   MC: official market close time.
   [MO and MC are calculated for each order: they may take into account symbol (US: some exchange traded funds close at 4:15pm, 15 min after stocks close), market, and unusual days (e.g., short day before holiday).]
   NOW: time at which end-user accesses custom interface to trade order.
The character sequence \+ is used to identify a time parameter that must be strictly greater than all other time parameters on the custom interface. This test is applied only when the end user clicks on the “Execute” button in the custom interface; the user is not restricted while setting the time parameter.
Example: a designer plans to expose two time parameters on the custom interface: Start Time and End Time. The designer wants to make sure that both parameter settings are legal times between now until market close, and that the user cannot set Start Time>=End Time. Furthermore, neither field can be left blank. The validation strings for Start Time and End Time respectively would be: “\#[Now,MC)” and “\#\+(Now,MC]”.

Boolean Type Parameters

There is no validation performed on Boolean type variables.

Step 3: Deploy Strategy and Interface

The stored custom strategy definition (strategy name, manifest, and custom parameters definition) is placed in a database where it can later be referenced by the pre-processor.

If desired, the custom strategy definition can be stored at the client or end user level so that the same custom strategy name can be associated with different strategy definitions depending on the specific end user. This also allows the designer to provide the same custom strategy to multiple clients but store and load different sets of default parameter values for each.

Once stored, the strategy name must be deployed on the end-user's trading system or workstation. Deploying a basic approach strategy is simpler, as it requires no interface integration or translation of parameters into the desired protocol. Generally, one can add the custom strategy to the workstation as a new electronic destination identified by its strategy name.

Deploying an advanced approach strategy is more complex, as it involves integrating an interface or otherwise providing a mechanism through which clients can specify parameter settings. And these parameter settings also must be passed to a trading system in the correct format, as per the parameter definition.

If an interface is integrated, it must be fully compliant with the definition specified by the Authoring Tool: format and layout, parameter availability, default values, parameter validation, and parameter passing.

When integrated properly, the end user will have the option to route orders to the new custom strategy from their workstation with the relevant interface (if any) appearing automatically to allow the user to set additional parameters, and with strategy name and any additional parameters passed to the pre-processor in the correct format.

Step 4: Process Incoming Client Orders

Once the strategy definitions have been created and stored, and the strategy has been fully deployed to the end user's workstation, the user is able to send custom strategy orders. To accommodate these orders, a pre-processor component may be used that converts simplified custom strategy orders into complex, fully-specified parent algorithm orders.

Incoming orders are routed through the pre-processor, which reads the incoming strategy name and then loads the appropriate custom strategy definition from the database, possibly contingent on the end user name. The pre-processor loads the strategy definition, incorporates passed-in parameters (if any), and passes the fully-specified order on to the parent trading algorithm. Note that since the manifest format is chosen to appear very similar to the FIX format used to control the parent algorithm, the pre-processor simply needs to splice in any passed-in values for dynamic parameters directly into the manifest in the appropriate places (as defined by the placeholders), append the resulting FIX message to the order, and then pass the order on to the parent algorithm.

Note that strictly speaking, Step 4 is not really a part of creating a new custom strategy. In other words, once the strategy is built, stored, and deployed, there are no additional steps to prepare the pre-processor to handle incoming orders for the new strategy.

Custom Strategy Example

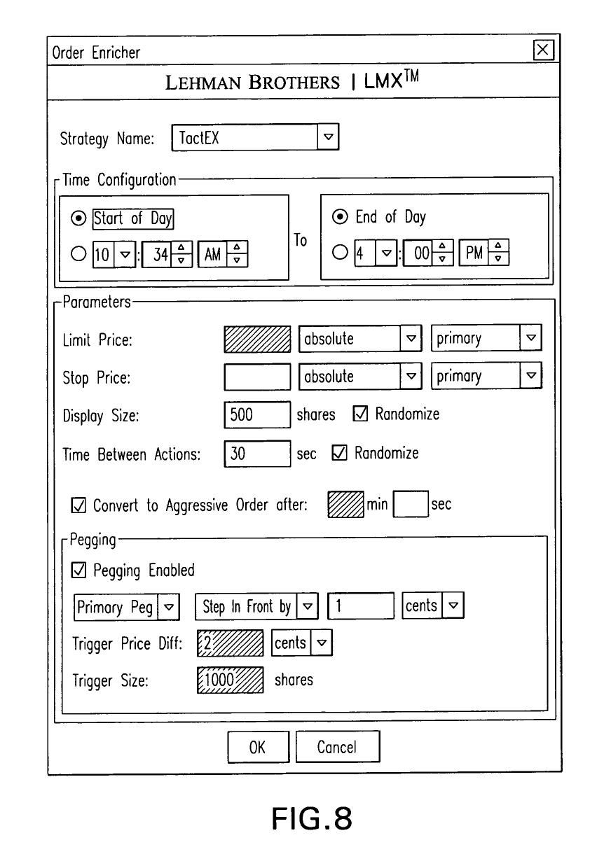

To illustrate the framework in action, a sample custom strategy based on the TactEx algorithm is used. FIG. 8 shows the definition of the strategy. White fields indicate nailed-down (pre-defined) parameters. Shaded fields indicate parameters that will be exposed to the end-user via custom interface. For the Trigger Price Diff and Trigger Size parameters, default values have been defined that will be represented in the interface.

The strategy definition consists of five pieces:
1. strategy name (say “Peg/Step In Front”);
2. parent algorithm (TactEx);
3. manifest;
4. custom parameters definition; and
5. custom interface definition.

The manifest enumerates the full list of TactEx algorithm parameters and identifies which have been nailed down vs. which can be set by the end user:

| Nailed Down | Exposed to End User |
|---|---|
| Start Time (=start of day) | Limit Price |
| End Time (=end of day) | Convert After Min |
| Limit Price Type (= absolute) | Trigger Price (default 2 |
| | cents) |
| Stop Price (=blank/not applicable) | Trigger Size (default |
| | 1000) |
| Stop Price Type (=absolute) | |
| Display Size (=500) | |
| Display Size Randomized? (=True) | |
| Time Between Actions (=30 sec) | |
| Time Between Actions Randomized? (=True) | |
| Convert to Aggressive? (=True) | |
| Convert After Sec (=blank) | |
| Pegging Enabled? (=True) | |
| Peg Anchor (=Primary) | |
| Peg Offset (=step in front by 1 cent) | |
| Trigger Price Diff Type (=cents) | |

In FIX message format (omitting numeric FIX tags for readability), the manifest would look like this:

```
      EffectiveTime=09:30:00
      ExpireTime=16:00:00
      RestrictionType=1
      RestrictionDirection=1
      RestrictionScope=1
      RestrictionLimitPrice=|LimitPrice|
      RestrictionType=2
      RestrictionMovementType=1
      RestrictionPriceType=1
      RestrictionMovement=1.0
      TargetStrategyParameters=<Parameters DisplaySize=”500”
RandomizeDisplaySize=“true” AverageTimeBetweenActions=“30”
RandomizeTimeBetweenActions=“true”
MinTilAggressive=“|ConvertMin|”
TriggerPriceDiff=“|PriceTrigger|” TriggerPriceDiffType=“Price”
TriggerSize=“|SizeTrigger|” />
```

The custom parameters definition looks like this (again, omitting FIX tags):

```
TargetStrategy = “Peg/Step In Front”
NoStrategyParameters = 4
      StrategyParameterName = “LimitPrice”
      StrategyParameterType = “Price”
      StrategyParameterValue = <place value here>
      StrategyParameterName = “ConvertMin”
      StrategyParameterType = “Integer”
      StrategyParameterValue = <place value here>
      StrategyParameterName = “PriceTrigger”
      StrategyParameterType = “Integer”
      StrategyParameterValue = <place value here>
      StrategyParameterName = “SizeTrigger”
      StrategyParameterType = “Integer”
      StrategyParameterValue = <place value here>
```

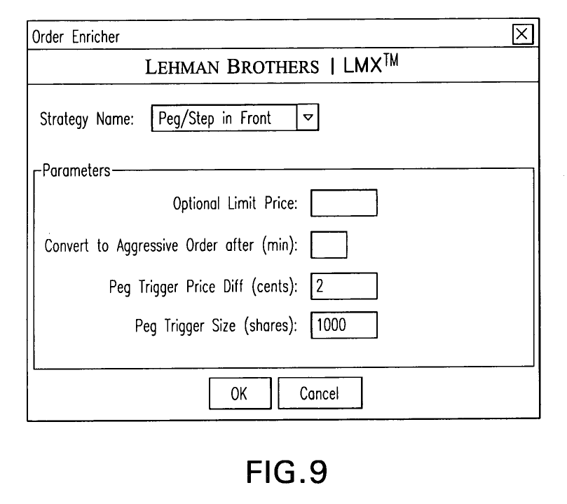

FIG. 9 shows the custom interface that will be exposed to the client. The four exposed parameters have been placed on the interface with labels and any desired default values.

The custom interface definition for this particular interface is as follows:

```
TargetStrategy = “Peg/Step In Front”
NoStrategyParameters = 4
      StrategyParameterName = “LimitPrice”
      StrategyParameterType = “Price”
      StrategyParameterValue = “”
      StrategyParameterLabel = “Optional Limit Price:”
      StrategyParameterControl = “Price”
StrategyParameterValidation = “(0.0,)”
      StrategyParameterName = “ConvertMin”
      StrategyParameterType = “Integer”
      StrategyParameterValue = “”
      StrategyParameterLabel =
      “Convert to Aggressive Order after (min):”
      StrategyParameterControl = “Integer”
StrategyParameterValidation = “[1,]”
      StrategyParameterName = “PriceTrigger”
      StrategyParameterType = “Integer”
      StrategyParameterValue = 2
      StrategyParameterLabel = “Peg Trigger Price Diff (cents):”
      StrategyParameterControl = “Integer”
StrategyParameterValidation = “[1,]”
      StrategyParameterName = “SizeTrigger”
      StrategyParameterType = “Integer”
      StrategyParameterValue = 1000
      StrategyParameterLabel = “Peg Trigger Size (shares):”
      StrategyParameterControl = “Integer”
      StrategyParameterValidation = “[1,]”
```

FIG. 10 depicts preferred steps (as described above) for building a custom strategy.

Authoring Tool Overview

This section describes a preferred authoring tool that may be used to create custom strategies based on the Conditional AutoTrader (“CAT”) parent algorithm. Conditional AutoTrader (CAT) is a flexible toolkit that enables designers to build custom execution algorithms on the fly. Every CAT strategy is made up of four components:
(a) overall Time Horizon for the order, comprising start and end times;
(b) Base Action, an algorithm (or other action) initially used to execute the order;
(c) Conditional Action, a second algorithm (or other action) triggered under pre-defined market conditions; and
(d) Condition, a set of rules that governs when and how the conditional action is triggered.

For more details on CAT, see co-pending U.S. patent application Ser. No. 11/387,994, entitled “Methods and Systems for Conditional Auto Trading,” filed Mar. 22, 2006, the entire contents of which are incorporated herein by reference. Although this description is focused on CAT as the parent algorithm, those skilled in the art will recognize that the description also applies, with appropriate modifications, to other trading algorithms (e.g., TactEx).

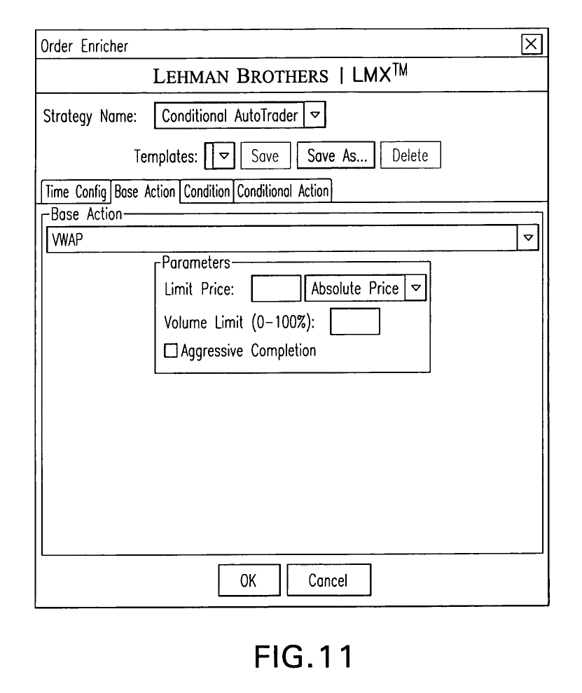

The authoring tool is an interactive, graphical environment used to design custom strategies and the interfaces used to control them. The authoring tool interface at first glance looks quite similar to the user interface for the CAT algorithm (see FIG. 11). Both interfaces present the user with a full set of CAT algorithm parameters and provide graphical controls that enable allow the user to set parameter values. One difference is that the CAT algorithm interface is used by a trader to specify parameter values and then send an order to CAT, while the custom CAT strategy authoring tool is used by a strategy designer to build a custom strategy and (optionally) an accompanying custom graphical interface that can be stored and then repeatedly used by traders.

The CAT algorithm interface is organized around four tabs (Time Config, Base Action, Condition, and Conditional Action), each tab corresponding to various parameters. The parameters visible on the Base Action and Conditional Action tabs further depend on an action choice specified at the top of the tab using a drop-down menu. Similarly, the parameters available on the Condition tab depend on a condition type choice, available from a drop-down menu at the top of the tab. The CAT authoring tool preferably has the same four-tab organizational structure.

The CAT algorithm interface allows the user (a trader) to set parameter values and then click “OK” button to send an order to CAT (or another trading algorithm) with all parameter value settings. The CAT authoring tool also allows parameter values to be set, but additionally allows the user (a designer) to categorize parameters into two groups: static and dynamic. Static parameters have pre-defined and fixed values for all orders processed by the custom strategy. Dynamic parameters are exposed to the end user and can be modified on an order-by-order basis. As described in the Custom Strategy Concept section herein, for each available CAT algorithm parameter, the authoring tool preferably gives the designer three options:
(4) designate it as a static parameter and fix (pre-define) the desired value;
(5) designate it as a dynamic parameter and expose it to the end user as a required input via custom interface or some electronic protocol; or
(6) designate it as a dynamic parameter and expose it to the end user as an optional input via custom interface or some electronic protocol.

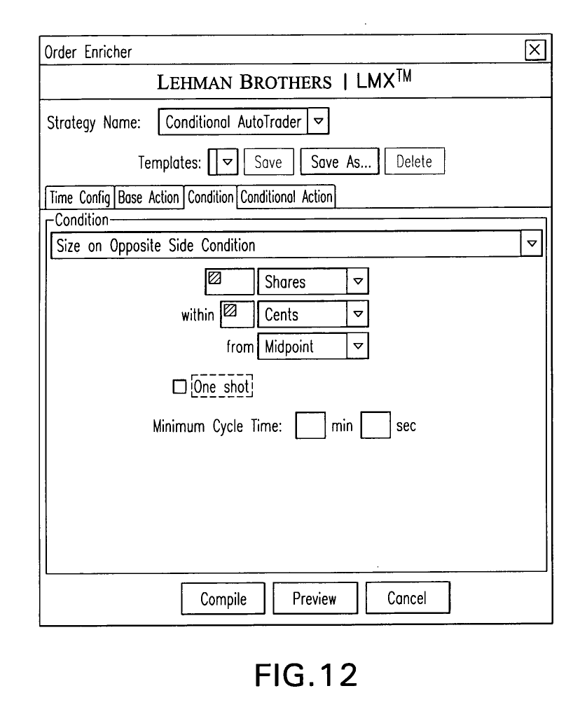

Within the authoring tool, all parameters can be defined and fixed (option (1) above), but only certain parameters can be exposed to the trader (options (2) or (3)). For example, the choice of base action, conditional action, or condition must be fixed in the custom strategy; those choices cannot be exposed to the trader. Fields that can be exposed are identified using a small checkbox (□) icon (see FIG. 12). For checkbox-enabled fields, the designer has four options:
1. Designate the parameter as static and fix a certain value by entering that value (or accepting the default value) and leaving the checkbox unchecked.
2. Designate the parameter as static and fix a blank value by leaving the parameter field blank and leaving the checkbox unchecked. Certain CAT parameters are required by the algorithm; for these parameters, one must enter a value. Attempting to fix a blank value for a required field will result in an error message.
3. Designate the parameter as dynamic and expose the parameter to the end user [trader] as a custom parameter without default value. To do this, the designer would check the checkbox but leave the parameter field blank.
4. Designate the parameter as static and expose the parameter to the end user [trader] as a custom parameter with default value. This is accomplished by entering the default value in the field and then checking the checkbox. When a custom interface for the strategy is presented to the trader, the parameter will be exposed on the interface with whatever default value the designer has specified.

There are buttons on the authoring tool interface that are not found on the algorithm interface:
Preview—View the custom interface so far; and
Compile—Create and store the strategy and interface, producing an error message if any required field has been left blank; required fields can be left blank only if they have been selected (in which case the custom interface will not display a default value).

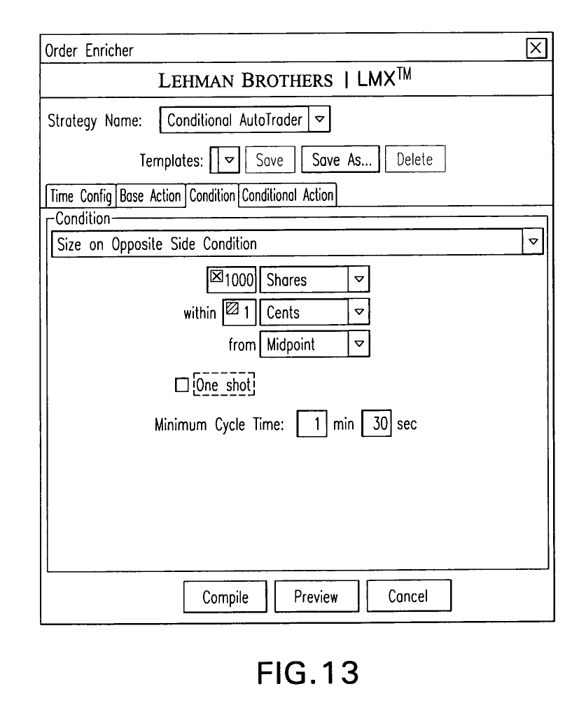

FIG. 13 shows an example of how a preferred CAT authoring tool screen may look as a designer is filling in parameter fields. FIG. 13 shows the condition screen. The designer has selected the Size On Opposite Side condition. Recall that the condition type (along with the base and conditional action types) must be predefined for the custom strategy. On this screen, the user has seven parameters to set. There are two parameters that can be exposed as dynamic parameters.

The designer has chosen to designate only the first (Size Threshold) parameter as dynamic by clicking the checkbox 1310 for this field. When selected, the box changes color and gets marked with an X. The user has specified a default value of 1000 for this parameter. Other parameters on the screen are static: Size Threshold Type=Shares, Range Threshold=1, Range Threshold Type=Cents, Range Anchor=Midpoint, One Shot=False, and Min Cycle Time=1 min 30 sec. In the designer's final custom strategy, all of these parameters will be fixed and hidden from the trader, with the exception of Trigger Size, which will be modifiable by the trader (either from a custom interface or by programmatically passing a parameter value along with an incoming order) with a default value of 1000 shares.

The application distinguishes between required and optional parameters. Parameters that are required by the parent algorithm (e.g., CAT) must be either fixed in advance by the designer or else filled in by the user when submitting an order. For required parameters, blank values are not allowed. Therefore, if a required variable is exposed to the trader on a custom interface, validation must be performed to prevent the user from attempting to execute the order with the required parameter left blank. Following the conventions described herein in the Custom Strategy Concept section, the \# sequence is used in the StrategyParameterValidation field for any required parameter which identifies the parameter as required.

List of Required Parameters for CAT Algorithm

(1) Parameters Required for All Custom CAT Strategies:
Start Time and End Time
Choice of Base Action (e.g., VWAP, Target Strike, etc.);
Choice of Condition (e.g., Price Condition); and
Choice of Conditional Action (e.g., VWAP, Target Strike, etc.).

(2) Parameters Required Given Choice of Base Action:

| | VWAP/ | | | |
|---|---|---|---|---|
| Base Action | TWAP | Target Strike | With Volume | Idle |
| Required | None | Urgency | Volume | None |
| Parameters | | | Target | |

(3) Parameters Required Given Choice of Condition:

| Condition | Price | Time | Size on Opp | Spread | Rel Return | Filled Size |
|---|---|---|---|---|---|---|
| Required | Price | Duration | Size | Spread | Ref Stock | Filled |
| Parameters | Threshold | | Threshold | Threshold | Rel Ret | Threshold |
| | Min Cycle | | Range | Min Cycle | Threshold | |
| | | | Threshold | | Min Cycle | |
| | | | Min Cycle | | | |

(4) Parameters Required Given Choice of Conditional Action:

| | VWAP/ | | | Fast | |
|---|---|---|---|---|---|
| Cond. Action | TWAP | Target Strike | With Volume | Exec | Idle |
| Required | Duration | Urgency | Volume | None | None |
| Parameters | | | Target | | |

Note that if the designer switches the choice of base action, conditional action, or condition, any parameter choices made relating to the previous choice are cleared.

For example, in FIG. 13 the designer has designated Trigger Size as a dynamic parameter to be exposed to the trader. If the designer were to then select a different condition type, the authoring tool would clear all dynamic (checked) parameters from this Size On Opposite Side condition screen before switching to the new condition screen. In other words, only parameters relevant to the selected base/conditional action types and condition type are exposable to the trader as dynamic parameters.

Steps to Author a Custom CAT Strategy
1. Use the authoring tool interface to choose the type of base and conditional actions (e.g., VWAP) and the type of condition (e.g., Price Condition) that will form the skeleton of the custom strategy. At this point, the set of parameters available to fix (static parameters) or expose (dynamic parameters) is limited to the parameters showing on each of the four tabs.
2. For each tab, use the authoring tool interface to assign desired static parameter values to be fixed. Some of the parameters need to be explicitly typed into an edit box. Others need to be chosen using a pulldown menu, radio button, or checkbox.
3. For each tab, click shaded checkboxes to identify any parameters to be exposed to the client as dynamic parameters and specify default values if desired. (See FIG. 13 for an example.)
4. Click the “Preview” button to preview the custom interface.
5. Click “Compile” to save the strategy and interface.

Using the Authoring Tool to Define a Custom CAT Strategy and Interface

This section will proceed screen by screen through the interface, identifying which fields can be exposed to the client as dynamic parameters. For each exposable field, the required elements of the custom parameters definition and custom interface definition are defined: parameter ID, parameter type (int, real, string, etc.), label to identify parameter on the GUI (graphical user interface), the GUI element type (edit box, checkbox, etc.), and any validation instructions for the parameter. Refer to the Custom Strategy Concept section for more information on these definitions.

Time Configuration Tab

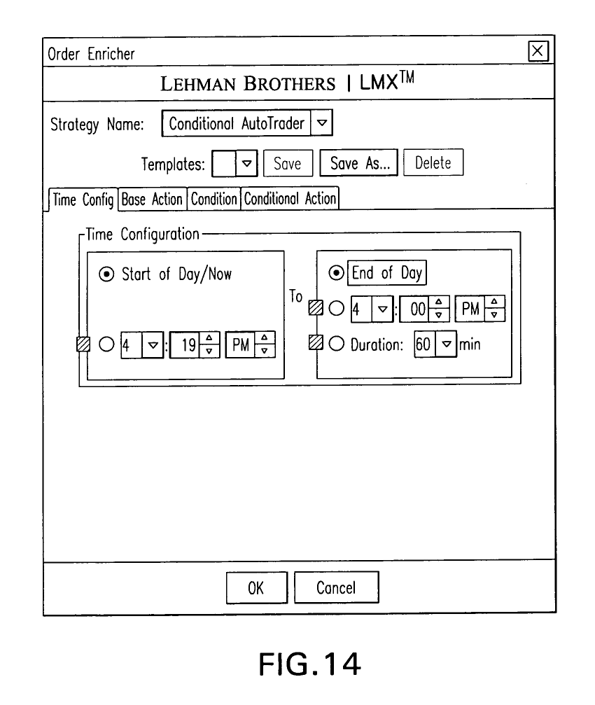

See FIG. 14. This tab features 3 exposable parameters:

| | | | | GUI | |
|---|---|---|---|---|---|
| Parameter | Parameter | Parameter | | Element | Validation |
| Name | ID | Type | GUI Label | Type | String |
| Start Time | StartTime | Time | Start Time | Time | \#[Now, MC) |
| End Time | EndTime | Time | End Time | Time | \#\+(Now, MC] |
| Duration | Duration | Integer | Order | Integer | \#[1, |
| | | | Duration | | MaxDuration] |
| | | | (minutes) | | |

Note that the two banks of radio buttons represent another parameter choice that is not exposable to the customer. For example, for start time, the designer must make a radio button selection between “Start of Day/Now” and an exact time. If the user selects “Start of Day/Now” then start time is fixed and the exact time parameter cannot be exposed to the trader. If, on the other hand, the designer selects the exact time radio button, then the designer has the option of fixing a time (leaving the shaded checkbox unchecked) or exposing the exact time control to the trader (with or without a default value). The end time works the same way. This means, for example, that the designer cannot expose both the exact end time parameter and the duration parameter to the trader simultaneously.

MaxDuration is defined as Mkt Close Time—MAX(Mkt Open Time, Time Now) (in integer minutes).

Base Action and Conditional Action Tabs

There are five possible base actions and six possible conditional actions, each listed below. Each choice is discussed separately, defining the exposable parameters for the chosen action.

| Base Actions | Conditional Actions |
|---|---|
| VWAP | VWAP |
| With Volume | With Volume |
| Target Strike | Target Strike |
| TWAP | TWAP |
| Idle | FastExec |
| | Idle |

Strategy choice is not exposed to the trader. In other words, a canned strategy is not created that allows users to choose between VWAP and With Volume as the base strategy. This choice must be made up front when the strategy is designed. Also, while each action has its own set of exposable elements, only selections pertaining to the chosen base and conditional actions will apply. For example, if the Target Strike base action is selected and the choice is made to expose the urgency slider, and then one subsequently changes to a With Volume base strategy, the checkmark for the Target Strike urgency slider element will be cleared automatically.

The Idle base action and conditional action choices have no parameters.

Note on Relative Limit Prices

Two types of limit prices are supported by all base and conditional actions except Idle: absolute and relative. If relative price limit is selected (in other words, if any selection other than “absolute price” is chosen from the drop-down menu on the base/conditional action screen), then the following relative limit price options are available: [cents/bps] [better/worse than] [Arrival Price/VWAP/Open/Prev Close/Arrival Opp Side/Arrival Same Side/Strike Price]. (For example, possible relative limit price options would include “cents better than VWAP” or “bps worse than Arrival Opp Side”.)

If a relative price limit is used and the designer chooses to expose the Limit Price field to the trader, then the GUI label for limit price should be appended with the relative limit price type selected. For example, if the designer fixes the limit price type as relative with “bps worse than Arrival Price”, then the GUI label for the limit price should be “Limit Price (bps worse than Arrival Price)”.

The parameter type, GUI Element type, and validation string for the Limit Price parameter field depend on the price limit type, as shown in the table below:

| | Parameter | GUI Element | Validation |
|---|---|---|---|
| Limit Price Type | Type | Type | String |
| Absolute | Price | Price | (0.00,) |
| Relative, denominated in | Integer | Integer | [0,) |
| cents | | | |
| Relative, denominated in | Real | Real | [0.0,) |
| bps | | | |

Base Action Tab: VWAP

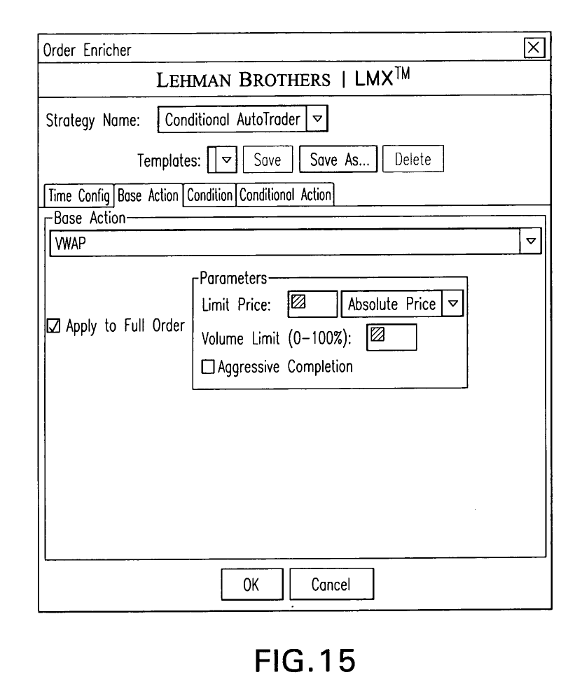

See FIG. 15. This tab features 2 exposable parameters:

| Parameter | | Parameter | GUI | GUI Element | Validation |
|---|---|---|---|---|---|
| Name | Parameter ID | Type | Label | Type | String |
| Limit | BasePriceLimit | See Note on Relative Limit Prices section above | | | |
| Price | | | | | |
| Volume | BaseVolumeLimit | Percent | Volume | Percent | (0.0, 1.0] |
| Limit | | | Limit (0-100%) | | |

In addition to the 2 exposable fields, the designer can fix two other parameter settings from this screen: the “Aggressive Completion” checkbox, and the limit price type. (See discussion above on limit price type and appending the GUI label for relative limit price types.) Note that the “Apply to Full Order” box is not part of the CAT algorithm interface. If this box is checked, the specified limit price will be applied to both the base and conditional action (as long as conditional action is not Idle).

Base Action Tab: TWAP

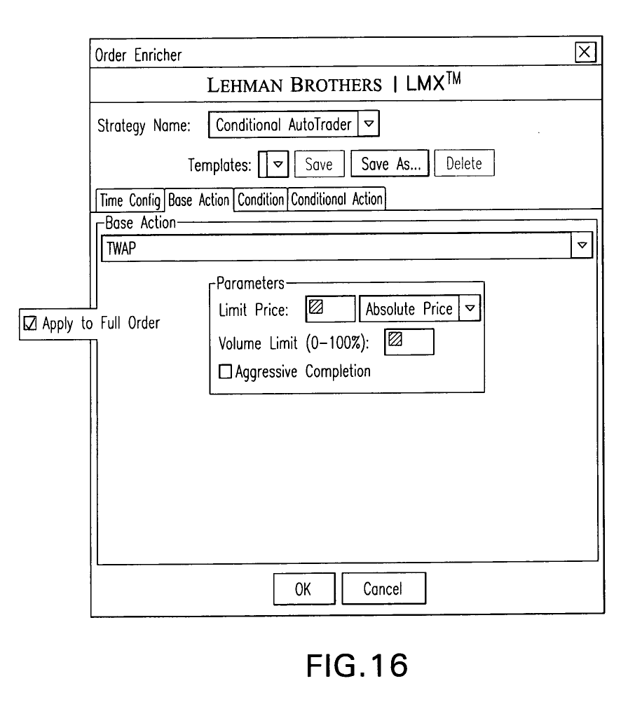

See FIG. 16. This tab features 2 exposable parameters:

| Parameter | | Parameter | GUI | GUI Element | Validation |
|---|---|---|---|---|---|
| Name | Parameter ID | Type | Label | Type | String |
| Limit | BasePriceLimit | See Note on Relative Limit Prices section above | | | |
| Price | | | | | |
| Volume | BaseVolumeLimit | Percent | Volume | Percent | (0.0, 1.0] |
| Limit | | | Limit (0-100%) | | |

In addition to the 2 exposable fields, the designer can fix two other parameter settings from this screen: the “Aggressive Completion” checkbox, and the limit price type.

Base Action Tab: with Volume

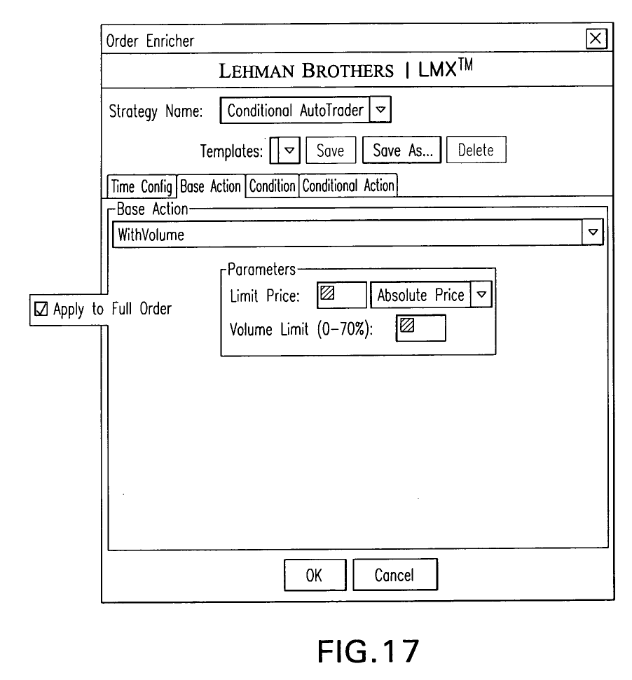

See FIG. 17. This tab features 2 exposable parameters:

| Parameter | | Parameter | GUI | GUI Element | Validation |
|---|---|---|---|---|---|
| Name | Parameter ID | Type | Label | Type | String |
| Limit | BasePriceLimit | See Note on Relative Limit Prices section above | | | |
| Price | | | | | |
| Volume | BaseVolumeTarget | Percent | Volume | Percent | \#(0.0, 0.7] |
| Target | | | Target (0-70%) | | |

In addition to the 2 exposable fields, the designer can fix the limit price type.

Base Action Tab: Target Strike

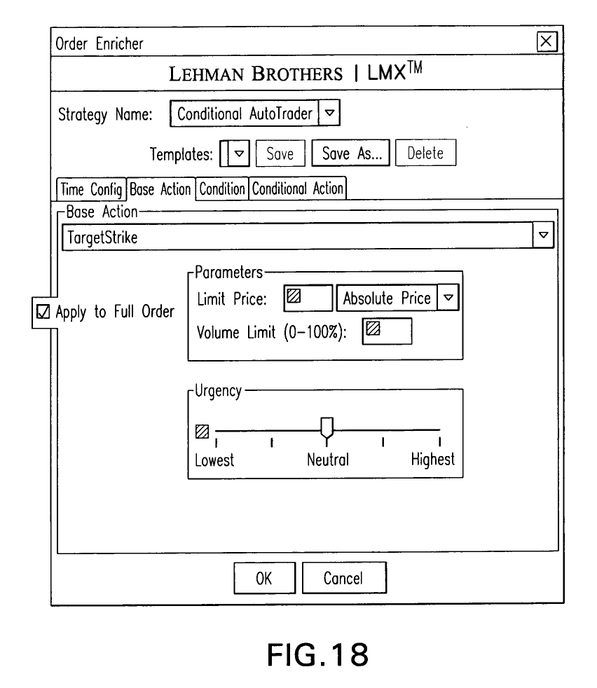

See FIG. 18. This tab features 3 exposable parameters:

| Parameter | | Parameter | GUI | GUI Element | Validation |
|---|---|---|---|---|---|
| Name | Parameter ID | Type | Label | Type | String |
| Limit | BasePriceLimit | See Note on Relative Limit Prices section above | | | |
| Price | | | | | |
| Volume | BaseVolumeLimit | Percent | Volume | Percent | (0.0, 1.0] |
| Limit | | | Limit (0-100%) | | |
| Urgency | BaseUrgency | Integer | Urgency | Integer | \#[1, 5] |
| | | | (1-5) | | |

In addition to the 3 exposable fields, the designer can fix the limit price type.

If there is a valid GUI element type to represent a slider, then that should be used instead. Here, an editbox with a positive integer input is used.

Conditional Action Tab: VWAP

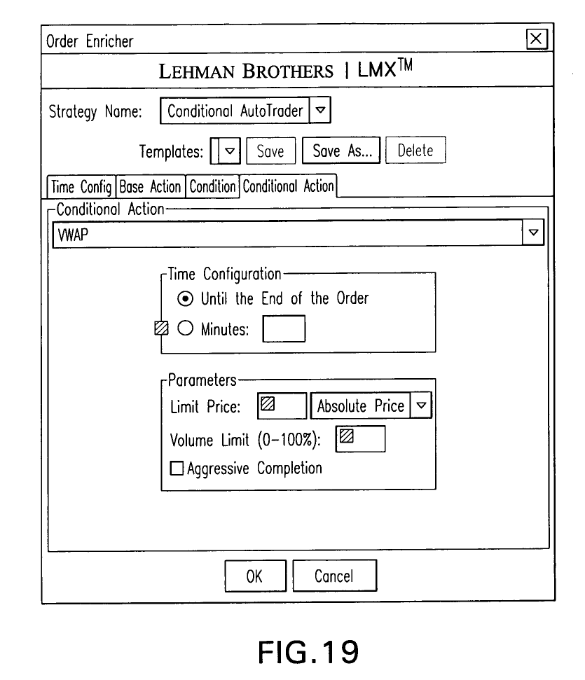

See FIG. 19. This tab features 3 exposable parameters:

| | | | | GUI | |
|---|---|---|---|---|---|
| Parameter | | Parameter | GUI | Element | |
| Name | Parameter ID | Type | Label | Type | Validation String |
| Limit | CAPriceLimit | See Note on Relative Limit Prices section above | | | |
| Price | | | | | |
| Volume | CAVolumeLimit | Percent | Volume | Percent | (0.0, 1.0] |
| Limit | | | Limit (0-100%) | | |
| Duration | CADuration | Integer | VWAP | Integer | \#[1, MaxDuration] |
| | | | Duration | | |
| | | | (minutes) | | |

In addition to the 3 exposable fields, the designer can fix three other parameter settings from this screen: time configuration radio box (“Until the End of the Order” or “Minutes”), the “Aggressive Completion” checkbox, and the limit price type. If the “Until the End of the Order” radio box is selected, then the duration (minutes) parameter is not exposable to the trader.

If the base action “Apply to Full Order” box is checked, then the Limit Price edit box on the conditional action tab (and the related drop-down menus and shaded checkbox) should be disabled; the base action limit price will then be applied to the conditional action as well.

Conditional Action Tab: TWAP

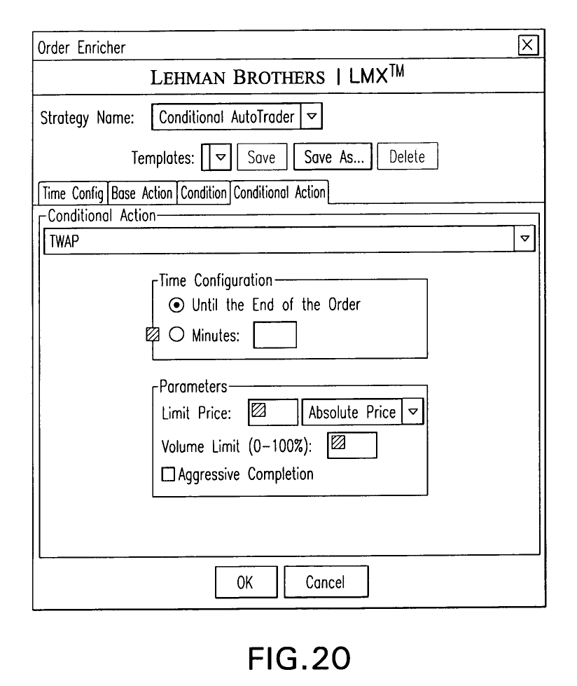

See FIG. 20. This tab features 3 exposable parameters:

| | | | | GUI | |
|---|---|---|---|---|---|
| Parameter | | Parameter | GUI | Element | |
| Name | Parameter ID | Type | Label | Type | Validation String |
| Limit | CAPriceLimit | See Note on Relative Limit Prices section above | | | |
| Price | | | | | |
| Volume | CAVolumeLimit | Percent | Volume | Percent | (0.0, 1.0] |
| Limit | | | Limit (0-100%) | | |
| Duration | CADuration | Integer | TWAP | Integer | \#[1, MaxDuration] |
| | | | Duration | | |
| | | | (minutes) | | |

In addition to the 3 exposable fields, the designer can fix three other parameter settings from this screen: time configuration radio box (“Until the End of the Order” or “Minutes”), the “Aggressive Completion” checkbox, and the limit price type.

If the base action “Apply to Full Order” box is checked, then the Limit Price edit box on the conditional action tab (and the related drop-down menus and shaded checkbox) should be disabled; the base action limit price will then be applied to the conditional action as well.

Conditional Action Tab: with Volume

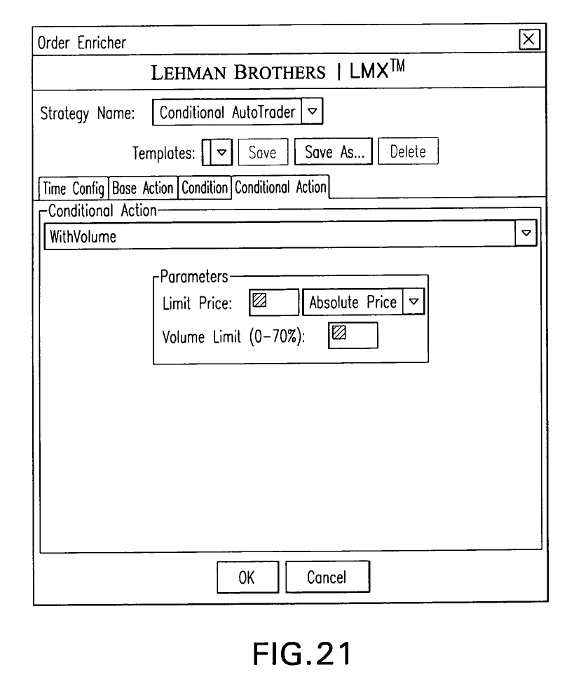

See FIG. 21. This tab features 2 exposable parameters:

| Parameter | | Parameter | GUI | GUI Element | Validation |
|---|---|---|---|---|---|
| Name | Parameter ID | Type | Label | Type | String |
| Limit Price | CAPriceLimit | See Note on Relative Limit Prices section above | | | |
| Volume | CAVolumeTarget | Percent | Volume | Percent | \#(0.0, 0.7] |
| Target | | | Target (0-70%) | | |

In addition to the 2 exposable fields, the designer can fix the limit price type.

If the base action “Apply to Full Order” box is checked, then the Limit Price edit box on the conditional action tab (and the related drop-down menus and shaded checkbox) should be disabled; the base action limit price will then be applied to the conditional action as well.

Conditional Action Tab: Target Strike

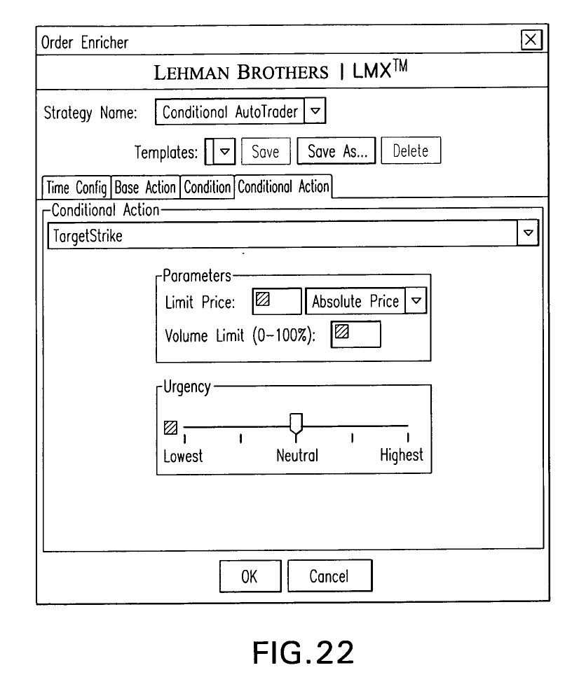

See FIG. 22. This tab features 3 exposable parameters:

| | | Pa- | | GUI | |
|---|---|---|---|---|---|
| Parameter | | rameter | GUI | Element | Validation |
| Name | Parameter ID | Type | Label | Type | String |
| Limit | CAPriceLimit | See Note on Relative Limit | | | |
| Price | | Prices section above | | | |
| Volume | CAVolumeLimit | Percent | Volume | Percent | (0.0, 1.0] |
| Limit | | | Limit | | |
| | | | (0-100%) | | |
| Urgency | CAUrgency | Integer | Urgency | Integer | \#[1, 5] |
| | | | (1-5) | | |

In addition to the 3 exposable fields, the designer can fix the limit price type.

If there is a valid GUI element type to represent a slider, then that should be used instead. Here, an editbox with a positive integer input is used.

If the base action “Apply to Full Order” box is checked, then the Limit Price edit box on the conditional action tab (and the related drop-down menus and shaded checkbox) should be disabled; the base action limit price will then be applied to the conditional action as well.

Conditional Action Tab: Fast Exec

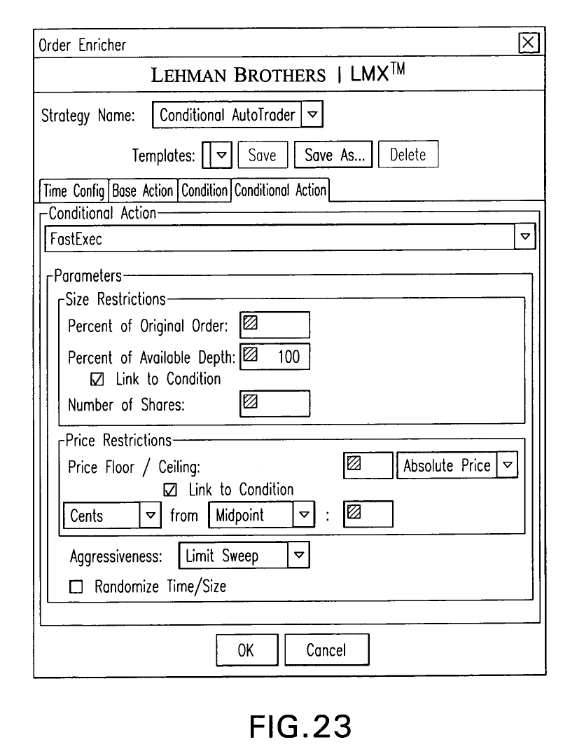

See FIG. 23. This tab features 5 exposable parameters:

| | | | | GUI | |
|---|---|---|---|---|---|
| Parameter | | Parameter | GUI | Element | Validation |
| Name | Parameter ID | Type | Label | Type | String |
| Percent of | FEOrderPercent | Percent | Size | Percent | (0.0, 1.0] |
| Order | | | Cap (% | | |
| | | | of | | |
| | | | Order) | | |
| Percent of | FEDepthPercent | Percent | Size | Percent | (0.0,) |
| Depth | | | Cap (% | | |
| | | | of | | |
| | | | Depth) | | |
| Number of | FENumShares | Integer | Size | Integer | (0,) |
| Shares | | | Cap | | |
| | | | (Shares) | | |

| Limit | CAPriceLimit | See Note on Relative Limit |
|---|---|---|
| Price | | Prices section above |
| Sweep | FESweepPrice | See below |
| Price | | |

In addition to the 5 exposable fields, the designer can fix the limit price type, the sweep price type (see below), the aggressiveness choice (“Limit Sweep” or “2 minutes VWAP”), and the Randomize Time/Size choice.

The sweep price type preferably takes the following format: [Cents/BPS/%/% Av Sprd] from [Midpoint/Opp Side/Same Side]. The default option (shown in FIG. 23) is “Cents from Midpoint”. Other choices may include “BPS from Opp Side” or “% Av Sprd from Same Side”. If the associated edit box is exposed to the client (“Sweep Price” in the table above), then the sweep price type should be used verbatim as the GUI label. If the sweep price is denominated in cents, then the parameter type and GUI element type are Integer and the validation string is “(0,)”. Otherwise, the parameter type and GUI element type are Real and the validation string is “(0.0,)”.

If either of the “Link to Condition” checkboxes is checked, that parameter's edit controls will be disabled (along with any associated drop-down menu and shaded checkbox) and the associated parameter will mirror the parameter value from the Size on Opposite Side condition. The “Number of Shares” parameter is linked to the first edit box (“Size Threshold”) on the Size on Opposite Side condition screen. The “Sweep Price” parameter (and all associated drop-down menus) are linked to the “within” edit box on the Size on Opposite Side condition screen. Note that the parameter values entered on the Size on Opposite Side condition screen need not be displayed on the Fast Exec screen for linked parameters; edit controls for linked parameters should simply be disabled.

If any condition type other than Size on Opposite Side is currently selected, both “Link to Condition” checkboxes will be disabled. Furthermore, if the “Size Threshold” on the Size on Opposite Side condition screen is currently denominated in anything other than shares (based on the drop-down menu), the “Link to Condition” checkbox next to the “Number of Shares” parameter on the Fast Exec screen should be disabled. Similarly, once either “Link to Condition” checkbox has been checked, the designer will not be able to switch to a different condition type without first unchecking the “Link to Condition” checkboxes. Finally, if the “Link to Condition” checkbox next to the “Number of Shares” parameter is checked, the designer will not be able to change the denomination of the “Size Threshold” on the Size on Opposite Side condition screen.

If the base action “Apply to Full Order” box is checked, then the Limit Price edit box on the conditional action tab (and the related drop-down menus and shaded checkbox) should be disabled; the base action limit price will then be applied to the conditional action as well.

Condition Tab

The Condition Tab provides six choices, each of which has its own set of associated parameter fields:
Conditions
Price Condition
Time Condition
Size on Opposite Side Condition
Bid/Ask Spread Condition
Relative Return Condition
Filled Size Condition

The choice of condition must be fixed by the designer and cannot be exposed to the trader when submitting an order for the canned strategy. And like the base/conditional action tabs, when the designer chooses a particular condition, any parameters fixed or exposed on any other condition screens are automatically erased. So, for example, if a designer were to choose the time condition and expose the duration tab to the trader and then choose a new condition tab, the time condition duration parameter would not be exposed to the trader.

Condition Tab: Price Condition

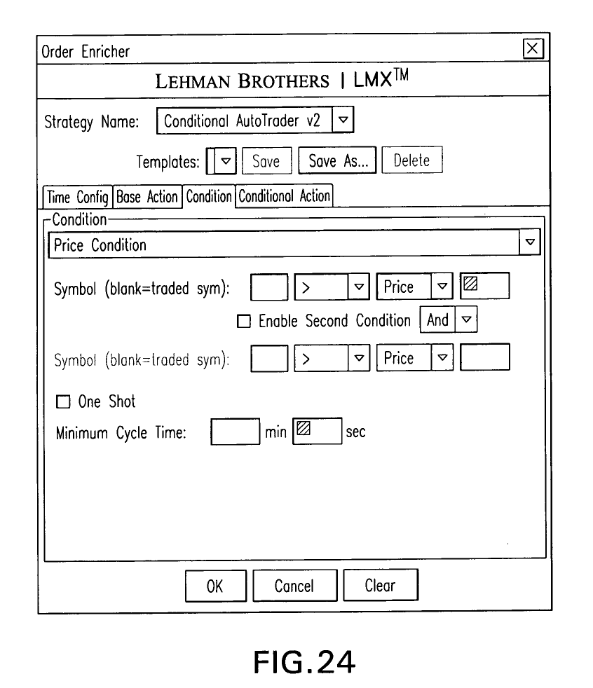

See FIG. 24. This tab features 2 exposable parameters:

| | | | | GUI | |
|---|---|---|---|---|---|
| Parameter | | Parameter | GUI | Element | Validation |
| Name | Parameter ID | Type | Label | Type | String |
| Price | PriceThreshold | See below | | | |
| Trigger | | | | | |
| Min Cycle | MinCycleSec | Integer | Min | Integer | \#[5,) |
| Time | | | Cycle | | |
| (Sec) | | | Time | | |
| | | | (Sec) | | |

In addition to these parameters, the designer can fix a number of other parameters:
First price condition:
   Symbol (may be left blank to indicate the symbol being traded)
   Operator (>/<)
   Trigger price type: absolute or relative (see below)
Second price condition:
   Second condition enabled/disabled (checkbox)
   AND/OR operator choice for combining the two conditions
   Symbol (may be left blank to indicate the symbol being traded)
   Operator (>/<)
   Trigger price type: absolute or relative (see below)
One Shot checkbox
Minimum cycle time (minutes value)

Note that the designer cannot expose anything related to the second price trigger condition. All of the parameter choices associated with the second condition can be fixed but not exposed.

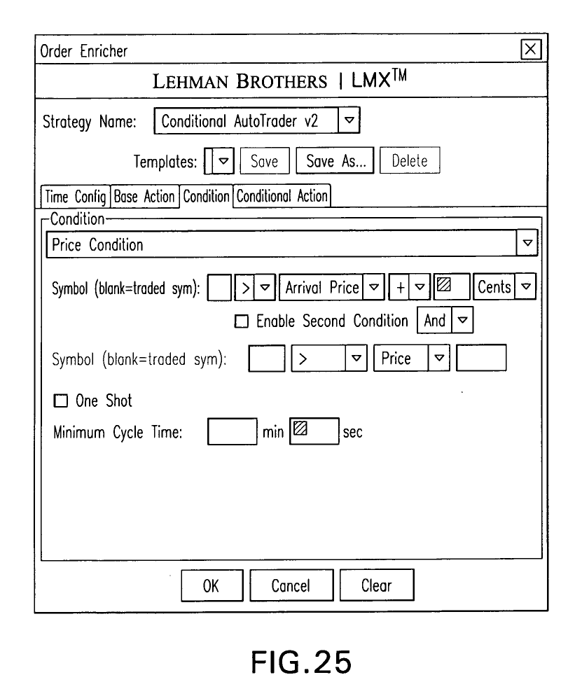

As is the case with limit prices for base/conditional actions, the trigger price for the price condition can be specified as an absolute price (e.g. “$38.50”) or a relative price (e.g. “75 bps above arrival price”). FIG. 24 shows an absolute trigger price type. FIG. 25 shows a relative trigger price type. Relative trigger price types take the following format: [Arrival Price/VWAP/Prev Close/Open/Ord Limit Price] [±] X [Cents/BPS]. For example: “VWAP—25 Cents”. For either relative or absolute trigger price types, the designer can expose only one parameter to the trader: the edit box containing either the price (absolute trigger price) or the offset number of cents/bps for the relative trigger price.

Refer to the section herein entitled Note on Relative Limit Prices for details on parameter type, GUI element type, GUI label, and validation for this parameter. One additional detail: if the symbol for the first price condition has been entered (rather than left blank), the GUI label for the trigger price should be prefixed with this symbol (e.g., “SPY Trigger Price”). Also, the Price Trigger parameter is required, so the validation field should start with the \# character sequence.

Condition Tab: Time Condition

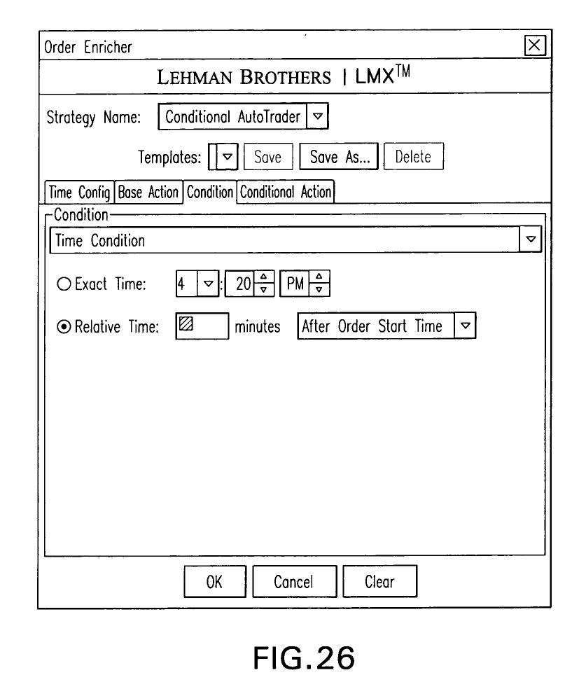

See FIG. 26. This tab features 1 exposable parameter:

| | | Pa- | | GUI | |
|---|---|---|---|---|---|
| Parameter | Parameter | rameter | GUI | Element | Validation |
| Name | ID | Type | Label | Type | String |
| Duration | CondDuration | Integer | See | Integer | \#[1, |
| | | | below | | MaxDuration] |

Additionally, the designer needs to pin down three additional variables: radio button choice between exact time and relative time, exact time (if selected), and relative time type. Relative time type has three options: minutes after order start time, minutes before order end time, or minutes before market close. This relative time type should be appended to the GUI label for Duration (e.g., “Time Trigger (minutes before end time)”).

Condition Tab: Size on Opposite Side Condition

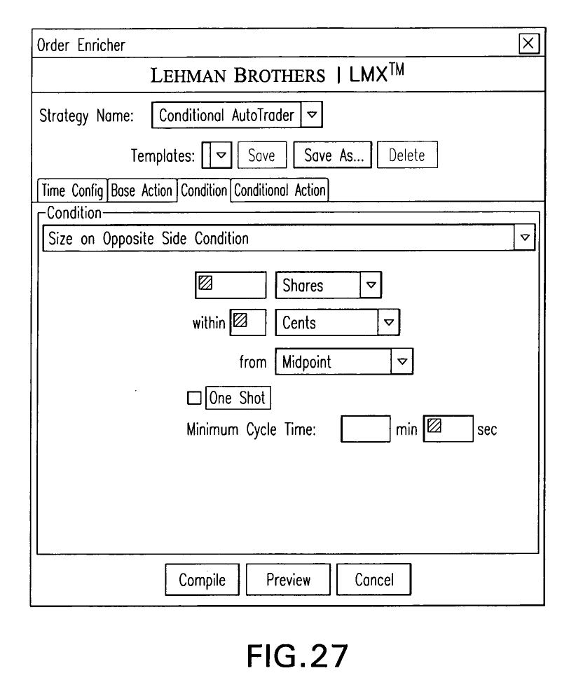

See FIG. 27. This tab features 3 exposable parameters:

| | | | | GUI | |
|---|---|---|---|---|---|
| Parameter | | Parameter | GUI | Element | Validation |
| Name | Parameter ID | Type | Label | Type | String |
| Size | SizeThreshold | See below | | | |
| Threshold | | | | | |
| Range | RangeThreshold | See below | | | |
| Threshold | | | | | |
| Min Cycle | MinCycleSec | Integer | Min | Integer | \#[5,) |
| Time | | | Cycle | | |
| (Sec) | | | Time | | |
| | | | (Sec) | | |

In addition, the designer can define five other parameters (all static):
Size Threshold Type (Shares, % Target Size, % Residual Size, % Typical Size)
Range Threshold Units (Cents, BPS, % Typical Spread)
Range Anchor (Midpoint, Opp Side of Quote, Same Side of Quote)
One shot checkbox
Min Cycle Time (minutes)

If the Size Threshold Type is “Shares”, the Size Threshold parameter type and GUI element type are Integer, and the validation string is “\#(0,)”. For all other Size Threshold Types, the Size Threshold parameter type and GUI type are Real, and the validation string is “\#(0.0,)”. In either case, GUI label is “Size Threshold (<Size Threshold Type>)”.

If Range Threshold Units is set to “Cents” then the Range Threshold parameter type and GUI element type are Integer, and validation string is “\#[0,)”. Otherwise, Range Threshold parameter type and GUI element type are Real and validation string is “\#[0.0,)”. In either case, the GUI label should read “Range (<Units> from <Anchor>)”. For example: “Range (BPS from Same Side of Quote)”.

On the Fast Exec screen (see FIG. 23), the designer has the option of linking either of two parameters to parameter settings from the Size on Opposite Side condition screen. This affects the behavior of this screen. See the section on the Fast Exec screen for more details.

Condition Tab: Bid/Ask Spread Condition

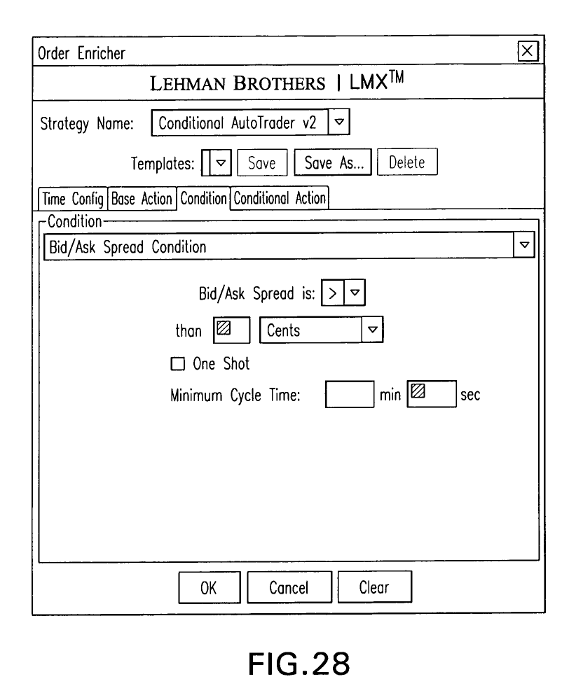

See FIG. 28. This tab features 2 exposable parameters:

| | | | | GUI | |
|---|---|---|---|---|---|
| Parameter | | Parameter | GUI | Element | Validation |
| Name | Parameter ID | Type | Label | Type | String |
| Spread | SpreadThreshold | See below | | | |
| Threshold | | | | | |
| Min Cycle | MinCycleSec | Integer | Min | Integer | \#[5,) |
| Time | | | Cycle | | |
| (Sec) | | | Time | | |
| | | | (Sec) | | |

In addition, the designer can define four other parameters (all static):
Operator (<,>)
Spread Threshold Units (Cents, BPS, % Typical Spread)
One shot checkbox
Min Cycle Time (minutes)

If Spread Threshold Units is set to “Cents” then the Spread Threshold parameter type and GUI element type are Integer, and validation string is “\#[0,)”. Otherwise, Spread Threshold parameter type and GUI element type are Real and validation string is “\#[0.0,)”. In either case, the GUI label should read “Spread Threshold (<Units>)”. For example: “Spread Threshold (Cents)”.

Condition Tab: Relative Return Condition

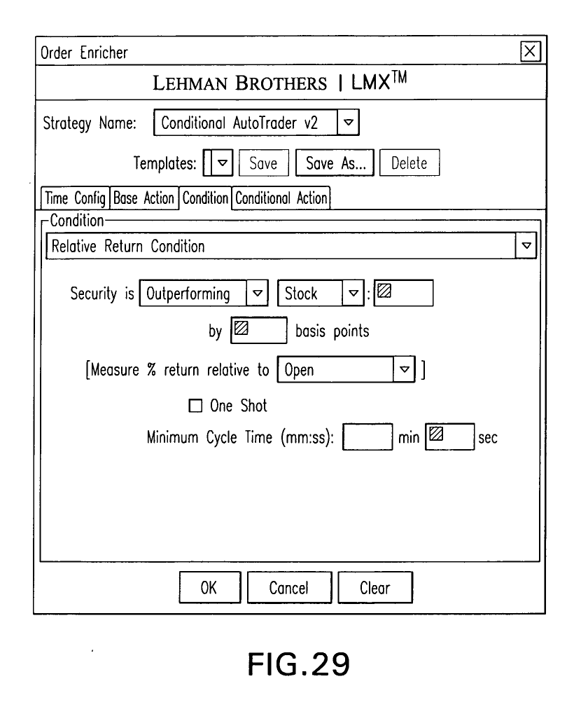

See FIG. 29. This tab features 3 exposable parameters:

| | | | | GUI | |
|---|---|---|---|---|---|
| Parameter | | Parameter | GUI | Element | Validation |
| Name | Parameter ID | Type | Label | Type | String |
| Reference Stock | RefStock | String | Reference Stock | Editbox | \# |
| | | | | | [anything |
| | | | | | but blank] |
| Relative | RelReturnThreshold | Integer | Relative | Integer | [1,) |
| Return | | | Return | | |
| Threshold | | | Spread | | |
| | | | Threshold | | |
| | | | (BPS) | | |
| Min Cycle | MinCycleSec | Integer | Min Cycle | Integer | \#[5,) |
| Time (Sec) | | | Time (Sec) | | |

In addition, the designer can define four other parameters (all static):
Spread Direction (Outperforming, Underperforming, B:Out/S:Under, B:Under/S:Out)
Reference Type (Stock, [later we will add Index as a second type])
One shot checkbox
Min Cycle Time (minutes)

Condition Tab: Filled Size Condition

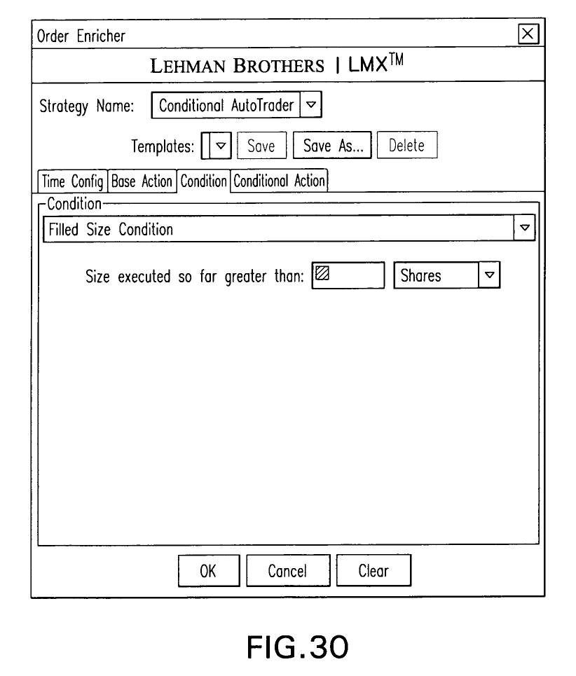

See FIG. 30. This tab features 1 exposable parameter:

| | | | | | |
|---|---|---|---|---|---|
| | | | | GUI | |
| Parameter | | Parameter | | Element | Validation |
| Name | Parameter ID | Type | GUI Label | Type | String |

| | | |
|---|---|---|
| Filled | FilledThreshold | See below |
| Threshold | | |

In addition, the designer can define one other static parameter: Filled Threshold Type (Shares or % of Original Order).

If Filled Threshold Type is Shares, then for Filled Threshold the following definitions apply: parameter type and GUI element type are Integer, GUI label is “Filled Size Threshold (Shares)”, and validation string is “(0,)”.

If Filled Threshold Type is % of Original Order, then for Filled Threshold the following definitions apply: parameter type and GUI element type are Real, GUI label is “Filled Size Threshold (% Order)”, and validation string is “(0.0,1.0)”.

The Preview Button

When the user clicks on the “Preview” button (see, e.g., FIG. 18), the authoring tool pops up a mock interface. This may be static (just a screen shot), but preferably is interactive, allowing the designer to test the functionality and validation. This preview feature must be able to support each of the GUI element types from the Custom Strategy Concept section herein (refer to that section for more details). The preview interface preferably is displayed in a separate pop-up frame.

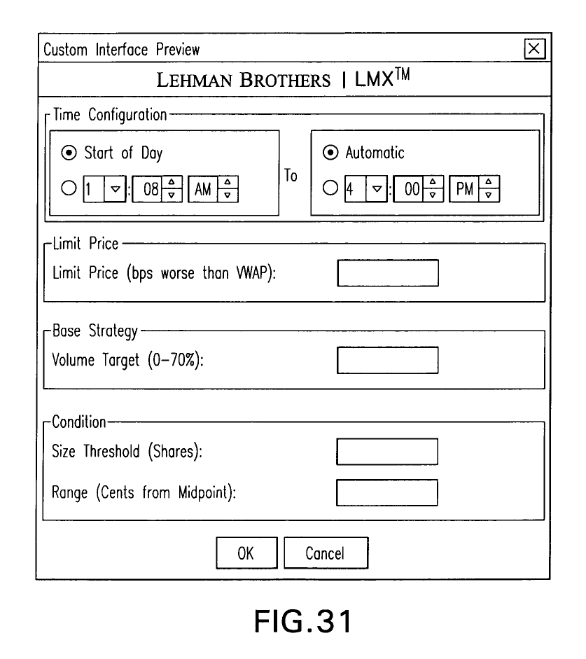

As shown in FIG. 31, the preview interface preferably has several sections.

The top section of the interface is divided into frames to section off parameters associated with the various parts of the CAT strategy:
Time Config
Limit Price
Base Action
Condition
Conditional Action

Only frames containing at least one dynamic variable are shown; empty frames are hidden (in this case, the conditional action frame is hidden). The Limit Price frame only applies if either (a) the base action is Idle, (b) the conditional action is Idle, or (c) the base action is exposed and the designer has checked the “Apply to Full Order” checkbox. If any of these apply, then there is at most one limit price that applies to the full order; this limit price parameter field is moved from the Base or Conditional Action section where it would normally be located and placed in its own section. All other sections correspond exactly to a tab of the CAT interface (and authoring tool). Any dynamic parameters exposed from one of the tabs are positioned on the interface in the section associated with the tab. In the case of Fast Exec parameters marked as “Link to Condition”, these parameters are placed in the Condition section and are displayed only once.

Parameter fields preferably are stacked vertically, never side by side. Each parameter field on the interface consists of the parameter GUI label (from the custom interface definition) followed by a “:” character and then the GUI element specified in the custom interface definition (checkbox, Integer edit box, etc.). For parameters with defined default values in the custom interface definition, the specified value is displayed in the GUI element as a default. If GUI labels are too long to display on one line, they can be broken up over several lines.

At the bottom of the preview interface are two buttons: “OK” and “Cancel”. If the preview interface is interactive, then clicking either of these buttons will close the preview pane.

If the preview interface is interactive, the validation instructions in the custom interface definition preferably are implemented for each parameter. In addition, basic type-related validation preferably is performed (the user is prevented from typing a character in an integer parameter field, and so on).

Note that in this CAT authoring tool example, the strategy designer has little direct control over the interface layout; the layout of the interface is generated automatically by the authoring tool. However, the general authoring tool functionality described herein extends to cover the case where the tool provides more control over interface layout. As those skilled in the art will recognize, a designer may be allowed to control anything from the ordering and labeling of fields to color schemes and even definitions of custom interface controls such as sliders and buttons.

The Compile Button

Pressing the Compile Button (see, e.g., FIG. 18) causes the authoring interface to attempt to store the strategy and interface. The first step is to make sure that all required parameters have been either exposed as dynamic parameters or assigned legal values as static parameters. If this is not the case, the authoring tool will present an error message to the designer calling attention to the undefined parameter and the strategy will not be stored.

Assuming this test is passed, the authoring tool will prompt the designer to specify a strategy name for the new custom strategy.

Then the authoring tool will write out the five portions of the custom strategy:
(1) Custom Strategy Name=<strategy name entered by the designer>
(2) Parent Algorithm=CAT. (Recall that every parent algorithm will have a separate authoring tool.)
(3) Manifest

As described in the Custom Strategy Concept section herein, the manifest format is closely modeled after the FIX message format used to specify parameter settings for a normal CAT order. All parameters that have been identified as static variables and pre-defined in the authoring tool can be transcribed into the manifest in exactly the way they would be defined in a FIX message representing a regular CAT order with the same parameter settings. Parameters that have been identified as dynamic variables will be transcribed into the manifest by positioning the Parameter ID (found in the table entry for the parameter in this description) nestled between two pipe (|) characters into the spot where the parameter setting would typically go. Effectively a placeholder is put into the spot in the FIX message normally reserved for the parameter setting, identifying the location where the pre-processor should splice a passed-in parameter value tagged with the unique ID identified by the placeholder. This is covered extensively in the Custom Strategy Concept section.

(4) Custom Parameters Definition

The FIX message representing the custom parameters definition will only be created if the strategy has at least one dynamic parameter exposed to the end user.

Each dynamic parameter exposed by the designer in the authoring tool (using the checkboxes provided) preferably has a repeating group entry in the format defined in the Custom Strategy Concept section. The parameter entry is built as follows:
StrategyParameterName=<Parameter ID from the table entry for the parameter in this document>
StrategyParameterType=<Parameter Type from the table entry for the parameter in this document>
StrategyParameterValue=“” [this field is only used for incoming orders, it is not used for strategy definition]

The top of the repeating list records the strategy name entered by the designer and the total number of dynamic parameters.

(5) Custom Interface Definition

The custom interface definition starts with a replica of the custom parameters definition. The blank StrategyParameterValue fields are overwritten with the default settings entered for each dynamic parameter by the designer. These default values may be blank, provided that the parameter in question is not identified as a required parameter. Each parameter's repeating group entry is then expanded by adding three new rows:
StrategyParameterLabel=<GUI Label from the table entry for the parameter in this document>
StrategyParameterControl=<GUI Element Type from the table entry for the parameter in this document>
StrategyParameterValidation=<Validation String from the table entry for the parameter in this document>

These five components are stored, and the authoring process is complete.

For additional background, the following information regarding recommended algorithmic trading extensions is provided.

Algorithmic Trading Extensions

Background:

The current FIX 4.4 version supports algorithmic trading through a combination of three strategy-related tags: TargetStrategy (tag 847), TargetStrategyParameters (tag 848) and ParticipationRate (tag 849). For most firms, there are a growing number of strategies that need additional parameters. Several firms have come up with a variety of implementations and have been adding custom tags to support their requirements.

Recommendations:

In order to standardize the passing of additional parameters for strategies and create a more flexible implementation to support algorithmic trading, the following are proposed:

1. Add a repeating group (shown below) to capture the parameters of a strategy. This repeating group will be added to all messages that currently have the TargetStrategy tag (tag 847). This includes message types D, E, G, 8, AB, AC, s, and t.

| Tag | Field | | Type | Description |
|---|---|---|---|---|
| 7 | NoStrategyParameters | | NumIn | Indicates number of |
| | | | Group | strategy parameters |
| → | 958 | StrategyParameterName | String | Name of parameter |
| → | 959 | StrategyParameterType | Int | Datatype of the |
| | | | | parameter. Refer to |
| | | | | Appendix-A for a list |
| | | | | of valid values. |
| → | 960 | StrategyParameterValue | String | Value of the parameter |

2. Deprecate tags TargetStrategyParameters (848) and ParticipationRate (849) (introduced in FIX 4.4).

3. In this approach, a VWAP strategy with specified start time and end time, and two additional parameters, participation rate (40%) and aggressiveness (Y), can be represented as follows:

847 (TargetStrategy)=1 (VWAP)

168 (EffectiveTime)=20050606-14:00:00

126 (ExpireTime)=20050606-20:00:00

957 (NoStrategyParameters)=2
958 (StrategyParameterName)=ParticipationRate
959 (StrategyParameterType)=11 (Percentage)
960 (StrategyParameterValue)=0.4
958 (StrategyParameterName)=Aggressiveness
959 (StrategyParameterType)=13 (Boolean)
960 (StrategyParameterValue)=Y

4. For firms/vendors that cannot support custom repeating groups in earlier versions of FIX, the strategy tags can be passed in tag 847 & 848 as follows:
Tag 847 will contain the strategy identifier
Tag 848 will contain a series of semi-colon delimited Tag:Value pairs
In the above example, tag 847 & 848 will be populated as follows:
847=1
848=957:2; 958:ParticipationRate; 959:11; 960:0.4; 958:Aggressiveness; 959:13; 960:Y

5. For firms/vendors that cannot implement tag 847, 848, 957-960 in earlier versions of FIX, they can use the corresponding user defined tags in the 5000 series—5847, 5848, 5957-5960.

6. In summary, the table below shows the recommended tags and alternatives:

| | | | Alternate | |
|---|---|---|---|---|
| | | | approach #2 | Alternate |
| | | Alternate | for firms/ | approach #3 for |
| | | approach #1 | vendors who | firms/vendors |
| | | for firms/ | can support | who cannot |
| | | vendors who | custom | support custom |
| | | cannot support | repeating | repeating groups |
| | | custom | groups but | and cannot |
| Recommended Approach | | repeating | cannot support | support tags 847 |
| for all FIX versions | | groups | tag 847, 957-960 | and 848 |
| 847 | TargetStrategy | 847 | 5847 | 5847 |
| 848 | TargetStrategyParameters - | Tag 848 | Deprecated | Tag 5848 |
| | Deprecated | containing | | containing semi- |
| 849 | ParticipationRate - | semi-colon | Deprecated | colon delimited |
| | Deprecated | delimited | | Tag: Value pairs |
| 957 | NoStrategyParameters | Tag: Value pairs | 5957 | |

| | | | |
|---|---|---|---|
| → | 958 | StrategyParameterName | 5958 |
| → | 959 | StrategyParameterType | 5959 |
| → | 960 | StrategyParameterValue | 5960 |

Valid Values for StrategyParameterType (tag 959)

| Tag | Field | Type | Description |
|---|---|---|---|
| 959 | StrategyParameterType | Int | Datatype of the parameter. |
| | | | Valid values: |
| | | | 1 = Int |
| | | | 2 = Length |
| | | | 3 = NumInGroup |
| | | | 4 = SeqNum |
| | | | 5 = TagNum |
| | | | 6 = Float |
| | | | 7 = Qty |
| | | | 8 = Price |
| | | | 9 = PriceOffset |
| | | | 10 = Amt |
| | | | 11 = Percentage |
| | | | 12 = Char |
| | | | 13 = Boolean |
| | | | 14 = String |
| | | | 15 = MultipleValueString |
| | | | 16 = Currency |
| | | | 17 = Exchange |
| | | | 18 = Month-Year |
| | | | 19 = UTCTimeStamp |
| | | | 20 = UTCTimeOnly |
| | | | 21 = LocalMktTime |
| | | | 22 = UTCDate |
| | | | 23 = Data |

Embodiments of the present invention comprise computer components and computer-implemented steps that will be apparent to those skilled in the art. For ease of exposition, not every step or element of the present invention is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the present invention.

For example, all calculations preferably are performed by one or more computers. Moreover, all notifications and other communications, as well as all data transfers, to the extent allowed by law, preferably are transmitted electronically over a computer network. Further, all data preferably is stored in one or more electronic databases.

We claim:

1. A computer system comprising:
an authoring tool operable to enable a user to design custom trading strategies and create interface definitions; and
a pre-processor operable to receive a custom strategy order message delivered via a standard protocol, load a definition for a corresponding custom strategy, enrich the order message based on said definition, and pass said enriched message to a trading strategy destination.

2. A computer system as in claim 1, wherein said definition is encoded using a protocol for encoding said custom trading strategies and interface definitions for transmission and storage.

3. A computer system as in claim 1, wherein said standard protocol is a FIX protocol.

4. A computer system as in claim 1, wherein said authoring tool is operable to enable a user to designate one or more input parameters as either a static parameter or a dynamic parameter.

5. A computer system as in claim 4, wherein said dynamic parameter may further be designated as a required input or an optional input.

6. A computer-implemented method comprising:
receiving a definition for an advanced approach strategy;
storing said definition for said advanced approach strategy in a database; and
based on said definition, integrating and deploying said advanced approach strategy.

7. A computer-implemented method as in claim 6, wherein said definition for an advanced approach strategy comprises: (a) a strategy name; (b) data identifying a parent algorithm; (c) a manifest; (d) a custom parameters definition; and (e) a custom interface definition.

8. A computer-implemented method as in claim 7, wherein said manifest enumerates a list of parameters of said parent algorithm and identifies which of said parameters are static and which are dynamic.

9. A computer-implemented method as in claim 6, wherein said parent algorithm is operable to receive FIX messages.

10. A computer-implemented method as in claim 6, wherein said manifest comprises one or more static parameter values and one or more dynamic parameter values.

11. A computer-implemented method as in claim 10, wherein said static parameter values are transcribed in a manner essentially identical to a manner in which said static parameter values would be defined in a FIX message.

12. A computer-implemented method as in claim 10, wherein a placeholder is used to identify a location where a passed-in value for a dynamic parameter should be inserted.

13. Software stored on a computer readable medium and operable to enable a user to author a custom trading strategy via a graphical user interface, wherein said graphical user interface is configured to allow said user to:
assign static parameter values to be fixed;
identify dynamic parameters to be exposed; and
set default values for said dynamic parameters.

14. Software as in claim 13, wherein said software is further operable to store a custom strategy comprising:
a parent algorithm name; and
a manifest.

15. Software as in claim 14, wherein said manifest comprises data identifying pre-defined static parameter values and dynamic parameters.

16. Software as in claim 15, wherein said manifest further comprises data identifying default parameter values for said dynamic parameters.

17. Software as in claim 13, wherein said graphical user interface is further configured to allow said user to identify one or more base actions, one or more conditional actions, and one or more conditions.

18. Software as in claim 14, wherein said manifest is stored as an XML string or a FIX string.

19. Software as in claim 14, wherein said software is further operable to store a custom strategy comprising at least one of: a custom parameters definition and a custom interface definition.

20. A computer system comprising:
an authoring tool operable to enable a user to design custom trading strategies and interfaces;
an order entry object interpreter operable to receive parameter values and form said values into a message transmitted via a standard protocol; and
a data structure packager operable to receive said message from said order entry object interpreter, form said message into a data structure, and transmit said data structure to a trading strategy destination.

21. A computer-implemented method comprising:
displaying a graphical user interface operable to allow a user to enter a definition for an advanced approach strategy;
receiving data entered by said user defining an advanced approach strategy; and
transmitting said definition for said advanced approach strategy to a parent algorithm.
